(19) United States
(12) Patent Application Publication
(10) Pub. No.: US 2003/0097481 A1
(43) Pub. Date: May 22, 2003

(54) Method and system for performing packet integrity operations using a data movement engine

(76) Inventor: Roger K. Richter, Leander, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 10/277,626

(22) Filed: Oct. 22, 2002

Related U.S. Application Data
(63) Continuation of application No. 09/797,413, filed on Mar. 1, 2001.
(60) Provisional application No. 60/353,561, filed on Jan. 31, 2002.

(51) Int. Cl. G06F 15/16

(52) U.S. Cl. 709/251; 709/230

(57) ABSTRACT

Systems and methods are provided for an improved TCP/UDP checksum method. The checksum methods described herein may be characterized as utilizing the system data movement engine, such as a direct memory access (DMA) engine, as part of the checksum process. The checksum process may be incorporated within the prescribed interface mechanisms utilized to move data across an interconnection medium. In this manner a TCP/UDP checksum process has been provided in which checksum generation is incorporated within the data movement engine utilized with a high speed interconnect medium (for example a switch fabric). Moreover, the checksum process may be split up and different operations performed at different steps of the packet transmission process. Thus, portions of the checksum process may be performed on either side of the interconnect medium during the transmission process.

This application claims priority on U.S. Provisional Patent Application serial No. 60/353,561 which was filed Jan. 31, 2002 and is entitled “Method And System Having Checksum Generation Using A Data Movement Engine”, the disclosure of which is incorporated herein by reference. This application is also a continuation in part of U.S. patent application Ser. No. 09/797,413 which was filed Mar. 1, 2001 and is entitled “Network Connected Computing System”, the disclosure of which is incorporated herein by reference.

### BACKGROUND OF THE INVENTION

The present invention relates to networking protocols and more particularly to checksum algorithms or other packet integrity algorithms.

The TCP-UDP/IP (Transport Control Protocol-User Datagram Protocol/Internet Protocol) suite is a well established networking protocol stack. Even though Media Access Control (MAC) layer hardware for Ethernet, HDLC and other network media utilizes their own Cyclic Redundancy Check (CRC) to verify media packet integrity, it is still necessary to verify end-to-end data integrity to ensure that intermediate forwarding nodes, client memory problems, and statistically remote errors have not corrupted the original packet data outside of media layer detection. Thus, as part of TCP-UDP/IP network protocol suite, checksum algorithms are implemented in order to verify data integrity of network packets that have traversed various network segments. Checksum algorithms have been implemented for the TCP-UDP layers (transport layers) and the IP layer (a network layer).

Checksum algorithms provide an error detection mechanism to verify a network packet by sending with the packet a numerical value based upon applying a known formula to the packet data. At the receiving node, the same formula is applied to the packet and the accompanying numerical value is checked. If the numerical values do not match an error has been detected. With regards to the transport layers, the TCP and UDP layers, a checksum is implemented with regard to the transport header and the entire payload. With regard to the network layer, the IP layer, a checksum is implemented with regard to the IP header.

FIGS. 2 and 3 illustrate the standard TCP packet 100 and UDP packet 110 respectively including TCP header 102 and TCP data payload 104 and UDP header 112 and UDP data payload 114. A sixteen bit TCP checksum field 106 and a sixteen bit UDP checksum field 116 are provided as shown. For TCP and UDP layers, a pseudo-header is conceptually prefixed to the TCP or UDP header. FIG. 4 illustrates the psuedo-header 120. FIG. 5 illustrates the standard IP header 140. The IP header is generally comprised of twenty bytes labeled in FIG. 4 as bytes 142 composed of five 32-bit fields. The IP header may further include option fields 144; however, the IP header generally includes such option fields less than 5% of the time. The IP header includes a sixteen bit checksum field 146.

Standardized TCP/UDP checksum operations are determined as follows. The checksum field is the 16-bit one's complement of the one's compliment sum of all 16-bit words that are included in the checksum calculation (headers and payload). If a packet contains an odd number of header and payload octets to be checksummed, the last octet is padded on the right with zeros to form a 16-bit word for checksum purposes. While computing the checksum, the checksum field itself, within the transport header, is replaced with all zeros. In one example, this operation may be implemented as four sub-operations: (A) first the data in the pseudo-header fields are accumulated as 16 bit quantities into a 32-bit accumulator; (B) then the UDP or TCP header fields and the data payload fields are accumulated as 16-bit quantities into the 32-bit accumulator; (C) then, any odd-sized data (odd byte) is accumulated as a zero padded 16-bit value; and (D) the 32-bit accumulated value is then processed for insertion into the TCP or UDP header by shifting, adding as 16-bit high and low order values and then one's complimenting the value and then storing the final value in the checksum field. An illustrative example of this is shown below in C code:

typedef struct PSEUDO_HDR
{

| | |
|---|---|
| unsigned int | src_ip_addr; |
| unsigned int | dest_ip_addr; |
| unsigned char | zero_pad; |
| unsigned char | proto_type; |
| unsigned short | checksum_field; |

} PSEUDO_HDR;
#if defined(LITTLE_ENDIAN)
#define PAD_MASK 0x00FF
#else
#define PAD_MASK 0xFF00
#endif
/***********************************************************
** The following function performs the UDP/TCP transport layer
** checksum algorithm. It receives 3 parameters:
** 1> a pointer to the transport pseudo-header;
** 2> a pointer to the UDP or TCP header and payload data
** 3> size of the preceding UDP/TCP hdr and data
** This allows the header/payload checksum to be generated
** separate from the pseudo header.
***********************************************************/
unsigned short transport_checksum( struct PSEUDO_HDR *psHdr,

| | |
|---|---|
| void | *pktData, |
| int | pktDataSize |

)

```
{
  register unsigned short *pShort;
  register unsigned int chksum = 0;
  register int i;
  /*
  * Step A: Checksum the pseudo header
  */
  pShort = (unsigned short *) psHdr;
  for ( i = 0; i < ((sizeof(struct PSEUDO_HDR) >> 1); i++)
  chksum += (unsigned int) *pShort[i];
  /*
  * Step B: Checksum the pkt header and data
  */
  pShort = (unsigned short *) pktData;
  for ( i = 0; i < (pktDataSize >> 1); i++)
  chksum += (unsigned int) *pShort[i];
  /*
  * Step C: Do checksum for odd-byte sized hdr/payload
  */
  if( (pktDataSize & 1) != 0 )
  chksum += (unsigned int) ((*pShort[(pktDataSize >> 1)] &
  PAD_MASK);
  /*
  * Step D: Process the 32-bit checksum value for insertion
  *  into the UDP/TCP header (shift, add, one's complement)
  */
  chkSum += (chkSum >> 16) + (chkSum & 0xFFFF);
  chkSum += (chkSum >> 16);
  return( (unsigned short)(˜chkSum & 0xFFFF) );
}
```

The TCP/UDP checksum operation is generally more complex and less deterministic then the IP checksum operation because the IP checksum operation covers only the IP header that is generally formed of a known length of twenty bytes and the TCP/UDP checksum further includes the pseudo-header and the data payload. Because TCP/UDP checksumming involves checksumming a pseudo-header, a TCP or UDP header and a variable length payload for every packet, a significant compute load is placed on the system CPU due to the large number of memory accesses. Thus an improved checksum process, particularly for TCP/UDP checksumming is desirable. Further, it is noted that the checksum fields described herein are in the header fields prior to the data payload. Because of this, checksums cannot easily be generated “on the fly” since the header that carries the checksum value precedes the actual data payload (the portion of the packet that is often the most important part of the checksum calculation). Thus, for example, a TCP or UDP packet must generally be held or stored “in-place” while a checksum value is generated since the checksum value must be stored, or verified, in the transport layer header before a packet is received or transmitted completely. Thus, one cannot start transmitting a packet and calculate the checksum simultaneously since the header includes the final checksum value. The requirement to “hold” a packet during checksum calculations causes packet latency and requires additional buffer capacity and complexity thus decreasing performance and/or increasing hardware costs to optimally process checksum.

One approach to address this problem has been the use of intelligent network interface cards to perform the checksum calculations. These network interface cards offload the checksum calculations from the other system components so as to increase the performance of the network attached computers or servers. However, this requires an increased buffer capacity (i.e. RAM) within the network interface cards. Typically, buffer capacity for buffering multiple packets for each processor on the network interface card must be provided. In addition, additional packet throughput latencies are now present in the network interface card because transmitted packets must be held in the network interface card memory for the checksum value to be calculated before the value may be inserted into the transport header for the final packet transmission. Likewise, received packets must be held in memory to validate checksum values before transferring the packet to the rest of the system.

The complexities and inefficiencies of TCP/UDP checksum operations are not limited to a monolithic systems communicating to separate external nodes of a network. Rather, these complexities and inefficiencies are also applicable to communications with multi-processor systems. Thus, multi-device I/O interconnection hardware or hardware/software systems suitable for distributing system functionality by selectively interconnecting two or more devices of a system through high speed interchange systems such as a switch fabric or bus architectures are also impacted by the TCP/UDP checksum operations.

Thus, it would be desirable to implement an improved checksum process. It would further be desirable to lessen the load placed upon the CPU and to implement a checksum process that may be accomplished on the fly. It would also be desirable to implement such improvements within the internal communication protocol within a multi-processor system.

### SUMMARY OF THE INVENTION

The invention described herein provides an improved checksum method. This improved method lessens the load placed upon system processors and allows the checksum process to be accomplished on the fly. In a broad sense, the checksum methods described herein may be characterized as utilizing the system data movement engine, such as the direct memory access (DMA) engine, as part of the checksum process.

The checksum techniques of the present invention are particularly useful for implementation in systems utilizing a distributed interconnect, such as for example, a switch fabric. However, it is also applicable to systems with I/O buses that allow devices to perform DMA operations (PCI, PCI-X, S-bus, etc.). Thus, in such systems part or all of the checksum process may be incorporated within the prescribed interface mechanisms utilized to move data across the interconnection medium. In this manner a TCP/UDP checksum process has been provided in which checksum generation is incorporated within the data movement engine utilized with a high speed interconnect medium (for example a switch fabric). Much of the checksum process may be performed as part of the data movement process across the medium without greatly increasing system costs or degrading system performance. Moreover, the checksum process may be split up and different operations performed at different steps of the packet transmission process. Thus, portions of the checksum process may be performed on either side of the interconnect medium during the transmission process.

In one embodiment, a checksum flag is provided in the DMA engine to indicate a checksum operation is to be performed. The DMA buffer control mechanism may also include a pointer or indicator that identifies on what portion of the packet the checksum operation is to begin. Finally, the checksum value may be appended to the end of the packet transmission buffer. The appended checksum value need not be the final checksum value, but rather may be an intermediate checksum value. The final checksum value may be obtained after transmission across the interconnect medium.

The checksum techniques described herein may be utilized with systems and methods for network connected computing systems that employ functional multi-processing to optimize bandwidth utilization and accelerate system performance. In one embodiment, the network connected computing system may include a switch based computing system. The system may further include an asymmetric multi-processor system configured in a staged pipeline manner. The network connected computing system may be utilized in one embodiment as a network endpoint system that provides content delivery. The disclosed systems may employ individual modular processing engines that are optimized for different layers of a software stack. Each individual processing engine may be provided with one or more discrete subsystem modules configured to run on their own optimized platform and/or to function in parallel with one or more other subsystem modules. A high speed distributive interconnect, such as a switch fabric, allows peer-to-peer communication between individual subsystem modules.

### BRIEF DESCRIPTION OF THE DRAWINGS

FIG. 1A is a representation of components of a content delivery system according to one embodiment of the disclosed content delivery system.

FIG. 1B is a representation of data flow between modules of a content delivery system of FIG. 1A according to one embodiment of the disclosed content delivery system.

FIG. 1C (shown split on two pages as FIGS. 1C′ and 1C″) is a simplified schematic diagram showing one possible network content delivery system hardware configuration.

FIG. 1D is a functional block diagram of an exemplary network processor.

FIG. 1E is a functional block diagram of an exemplary interface between a switch fabric and a processor.

FIG. 2 illustrates a TCP header including a TCP checksum field.

FIG. 3 illustrates a UDP header including a UDP checksum field.

FIG. 4 illustrates a TCP/UDP pseudo-header.

FIG. 5 illustrates an IP header including an IP checksum field.

FIG. 6 illustrates a buffer descriptor control block for use with a DMA engine.

### DESCRIPTION OF ILLUSTRATIVE EMBODIMENTS

The invention described herein provides an improved checksum method. This improved method lessens the load placed upon system processors and allows the checksum process to be accomplished on the fly. The improved checksum method is particularly well suited for the communications across an interconnect medium within a multi-device system.

In one embodiment, the checksum method described herein may be implemented in any multi-node I/O interconnection hardware or hardware/software system suitable for distributing functionality by selectively interconnecting two or more devices of a system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, S-Bus, Microchannel, VME, etc.

In a broad sense, the checksum methods described herein may be characterized as utilizing the system direct memory access (DMA) engine as part of the checksum process. In multi-device computing systems, two well-known data transfer modes include programmed input/output (PIO) and DMA. In PIO systems, the CPU's registers may be utilized for data transfer between main memory and a peripheral device. In DMA systems, typically specialized circuitry, dedicated microprocessors, or dedicated controllers may cooperate with the operating system to directly transfer data from memory to a peripheral device (or from memory to memory) without utilizing the CPU.

According to the techniques disclosed herein, “on the fly” TCP/UDP checksum generation is provided utilizing a DMA engine. For example, a DMA engine may be utilized to allow packet data movement to/from a first local memory and to/from another local memory location, memory on another processor, memory or an intelligent I/O device, etc. The DMA engine may utilize buffer descriptor control blocks or other control mechanism that are chainable in memory to describe the memory blocks for receiving or transmitting packets. These buffer descriptor control blocks or other control mechanism may typically include flags that allow the controlling software to signal the DMA engine when buffers are ready for reception or transmission, flags that indicate receive errors, flags that indicate transmit errors, flags that indicate a general interrupt, etc. In addition, according to the invention provided herein, a checksum flag may also be included in the buffer descriptor control block.

The checksum flag may be utilized to indicate that checksum operations are to be performed by the DMA engine as part of the packet transmission/reception. For example when the checksum flag is indicating a checksum operation for a packet transmission, the DMA engine will perform a checksum operation and may append the checksum information at the end of the packet transmission buffer as described in more detail below.

The buffer descriptor control blocks may include, in addition to the checksum flag, a payload offset value. The payload offset value indicates where in the packet buffers the checksum algorithm is to start. Thus, a simple offset notation may be provided to indicate where the data that is to be checksummed begins. Then when a checksum value is obtained, the checksum value is appended to the end of the packet buffer. Thus, the DMA engine does not attempt to place the generated checksum value in the packet header. For reception, the DMA engine may receive the checksum value and verifies the checksum value on the remaining packet data and indicate a receive status error in the associated buffer descriptor on the fly. The techniques described herein are not required to be utilized for both checksum generation during transmission and checksum verification during reception. Thus, for example the checksum techniques disclosed herein may be utilized even though these techniques are not utilized for reception checksum verification.

Thus, a technique is provided in which checksum operations may be performed within a computing system utilizing the computing systems DMA engine. Extensive buffer and complex logic in the DMA engine is not necessary. Further, additional packet transmission or reception latencies are minimized since the checksum value is appended on the back of the payload allowing on the fly checksum generation and verification without the computationally intensive processing being deferred until an entire packet is buffered.

As will be described in more detail below, the checksum operation does not have to be entirely performed prior to a checksum value being appended to the end of a packet buffer by the DMA engine. For example, as described above a checksum operation has been divided into four sub-operations A, B, C, and D. In one embodiment, the first three operations (A-C) may be performed by the DMA engine and appended to the packet buffer for transmission between the various locations within the system. The last operation related to insertion into the header (shifting, adding as 16-bit high and low order values and then one's complimenting the value prior to storing in the header checksum field) may be done just prior to a packet being transmitted from the system to an external network. The last operation may be identified as a checksum store operation, i.e., the final checksum value is stored in the appropriate format in the header checksum field.

In one embodiment, the TCP/UDP checksum techniques disclosed here may be implemented in a functional multi-processor network connected computing system. An exemplary system is described in co-pending U.S. patent application Ser. No. 09/879,801 entitled “Systems and Methods For Providing Differentiated Service In Information Management Environments,” filed Jun. 12, 2001, the disclosure of which is expressly incorporated herein by reference.

Disclosed herein are systems and methods for operating network connected computing systems that may utilize the TCP/UDP checksum techniques. The network connected computing systems disclosed provide a more efficient use of computing system resources and provide improved performance as compared to traditional network connected computing systems. Network connected computing systems may include network endpoint systems. The systems and methods disclosed herein may be particularly beneficial for use in network endpoint systems. Network endpoint systems may include a wide variety of computing devices, including but not limited to, classic general purpose servers, specialized servers, network appliances, storage area networks or other storage medium, content delivery systems, corporate data centers, application service providers, home or laptop computers, clients, any other device that operates as an endpoint network connection, etc.

Other network connected systems may be considered a network intermediate node system. Such systems are generally connected to some node of a network that may operate in some other fashion than an endpoint. Typical examples include network switches or network routers. Network intermediate node systems may also include any other devices coupled to intermediate nodes of a network.

Further, some devices may be considered both a network intermediate node system and a network endpoint system. Such hybrid systems may perform both endpoint functionality and intermediate node functionality in the same device. For example, a network switch that also performs some endpoint functionality may be considered a hybrid system. As used herein such hybrid devices are considered to be a network endpoint system and are also considered to be a network intermediate node system.

For ease of understanding, the systems and methods disclosed herein are described with regards to an illustrative network connected computing system. In the illustrative example the system is a network endpoint system optimized for a content delivery application. Thus a content delivery system is provided as an illustrative example that demonstrates the structures, methods, advantages and benefits of the network computing system and methods disclosed herein. Content delivery systems (such as systems for serving streaming content, HTTP content, cached content, etc.) generally have intensive input/output demands.

It will be recognized that the hardware and methods discussed below may be incorporated into other hardware or applied to other applications. For example with respect to hardware, the disclosed system and methods may be utilized in network switches. Such switches may be considered to be intelligent or smart switches with expanded functionality beyond a traditional switch. Referring to the content delivery application described in more detail herein, a network switch may be configured to also deliver at least some content in addition to traditional switching functionality. Thus, though the system may be considered primarily a network switch (or some other network intermediate node device), the system may incorporate the hardware and methods disclosed herein. Likewise a network switch performing applications other than content delivery may utilize the systems and methods disclosed herein. The nomenclature used for devices utilizing the concepts of the present invention may vary. The network switch or router that includes the content delivery system disclosed herein may be called a network content switch or a network content router or the like. Independent of the nomenclature assigned to a device, it will be recognized that the network device may incorporate some or all of the concepts disclosed herein.

The disclosed hardware and methods also may be utilized in storage area networks, network attached storage, channel attached storage systems, disk arrays, tape storage systems, direct storage devices or other storage systems. In this case, a storage system having the traditional storage system functionality may also include additional functionality utilizing the hardware and methods shown herein. Thus, although the system may primarily be considered a storage system, the system may still include the hardware and methods disclosed herein. The disclosed hardware and methods of the present invention also may be utilized in traditional personal computers, portable computers, servers, workstations, mainframe computer systems, or other computer systems. In this case, a computer system having the traditional computer system functionality associated with the particular type of computer system may also include additional functionality utilizing the hardware and methods shown herein. Thus, although the system may primarily be considered to be a particular type of computer system, the system may still include the hardware and methods disclosed herein.

As mentioned above, the benefits of the systems described herein are not limited to any specific tasks or applications. The content delivery applications described herein are thus illustrative only. Other tasks and applications that may incorporate the principles of the present invention include, but are not limited to, database management systems, application service providers, corporate data centers, modeling and simulation systems, graphics rendering systems, other complex computational analysis systems, etc. Although the principles of the present invention may be described with respect to a specific application, it will be recognized that many other tasks or applications performed with the hardware and methods may utilize the present invention.

Disclosed herein are systems and methods for delivery of content to computer-based networks that employ functional multi-processing using a “staged pipeline” content delivery environment to optimize bandwidth utilization and accelerate content delivery while allowing greater determination in the data traffic management. The disclosed systems may employ individual modular processing engines that are optimized for different layers of a software stack. Each individual processing engine may be provided with one or more discrete subsystem modules configured to run on their own optimized platform and/or to function in parallel with one or more other subsystem modules across a high speed distributive interconnect, such as a switch fabric, that allows peer-to-peer communication between individual subsystem modules. The use of discrete subsystem modules that are distributively interconnected in this manner advantageously allows individual resources (e.g., processing resources, memory resources) to be deployed by sharing or reassignment in order to maximize acceleration of content delivery by the content delivery system. The use of a scalable packet-based interconnect, such as a switch fabric, advantageously allows the installation of additional subsystem modules without significant degradation of system performance. Furthermore, policy enhancement/enforcement may be optimized by placing intelligence in each individual modular processing engine.

The network systems disclosed herein may operate as network endpoint systems. Examples of network endpoints include, but are not limited to, servers, content delivery systems, storage systems, application service providers, database management systems, corporate data center servers, etc. A client system is also a network endpoint, and its resources may typically range from those of a general purpose computer to the simpler resources of a network appliance. The various processing units of the network endpoint system may be programmed to achieve the desired type of endpoint.

Some embodiments of the network endpoint systems disclosed herein are network endpoint content delivery systems. The network endpoint content delivery systems may be utilized in replacement of or in conjunction with traditional network servers. A “server” can be any device that delivers content, services, or both. For example, a content delivery server receives requests for content from remote browser clierits via the network, accesses a file system to retrieve the requested content, and delivers the content to the client. As another example, an applications server may be programmed to execute applications software on behalf of a remote client, thereby creating data for use by the client. Various server appliances are being developed and often perform specialized tasks.

As will be described more fully below, the network endpoint system disclosed herein may include the use of network processors. Though network processors conventionally are designed and utilized at intermediate network nodes, the network endpoint system disclosed herein adapts this type of processor for endpoint use.

The network endpoint system disclosed may be construed as a switch based computing system. The system may further be characterized as an asymmetric multi-processor system configured in a staged pipeline manner.

Exemplary System Overview

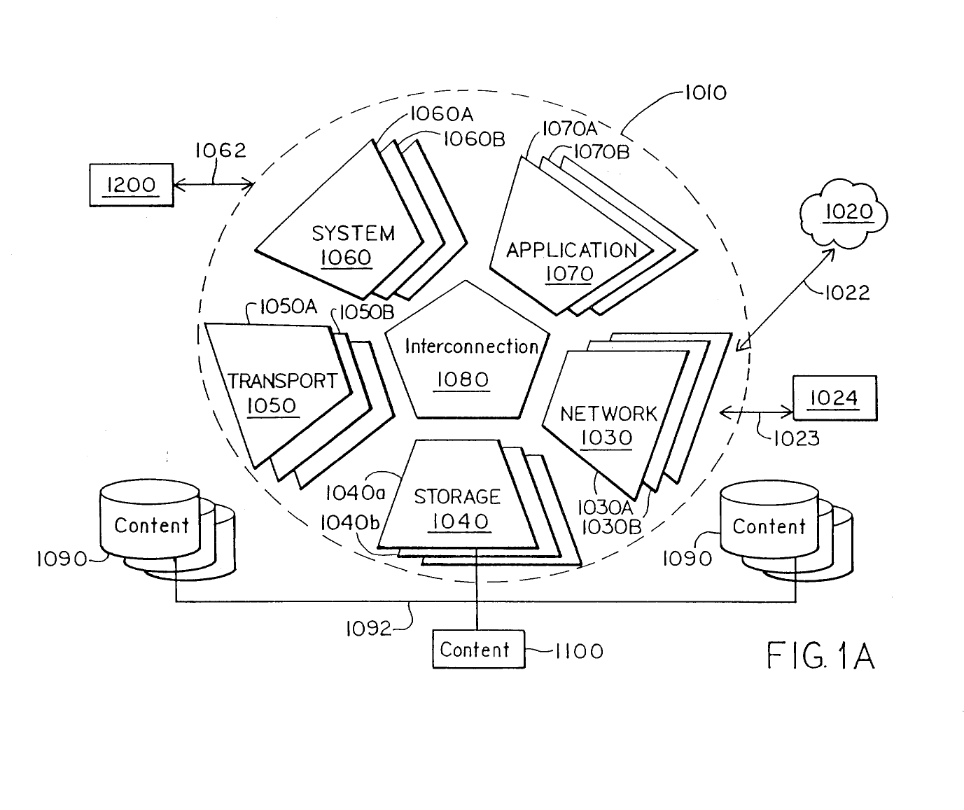

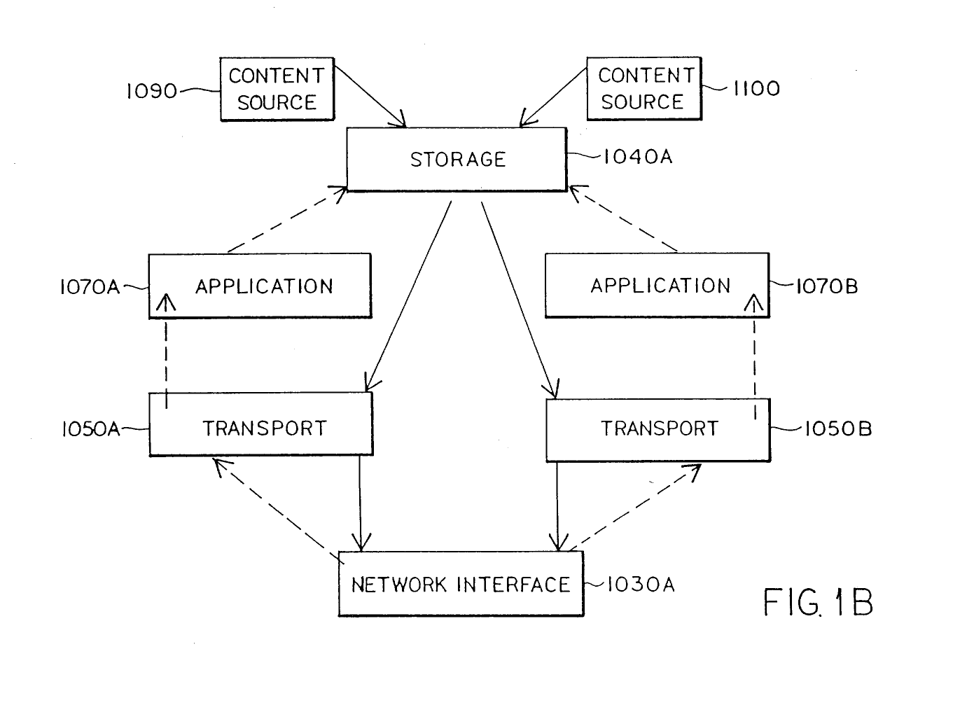

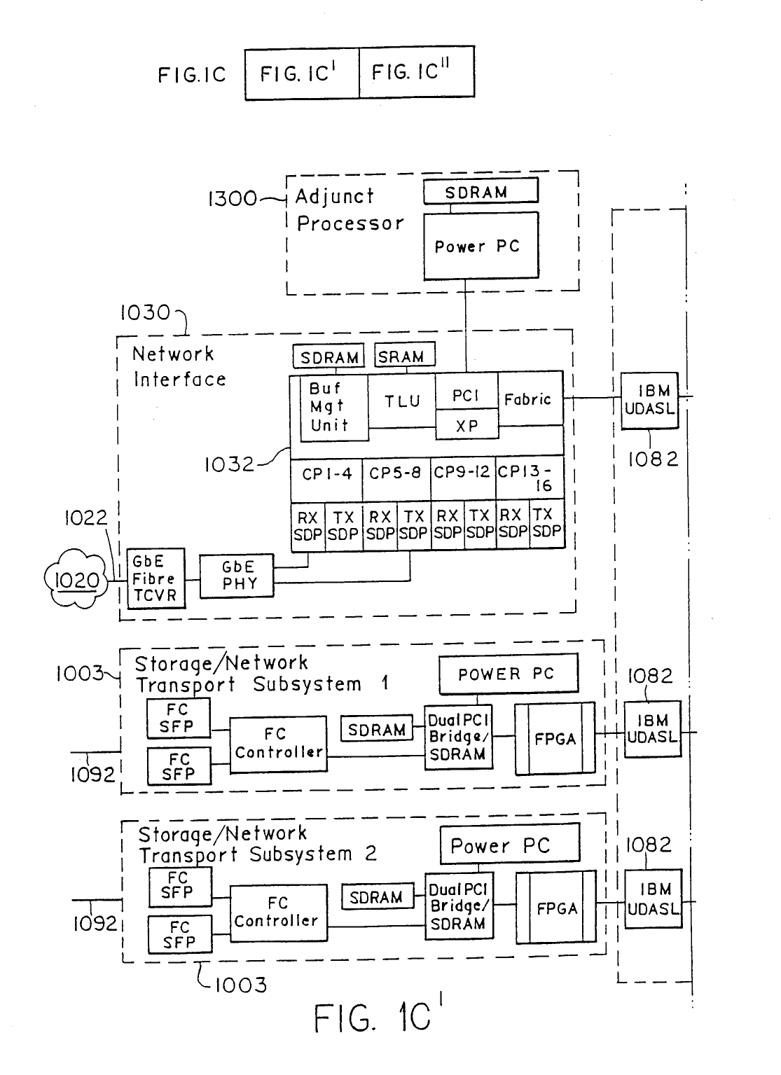

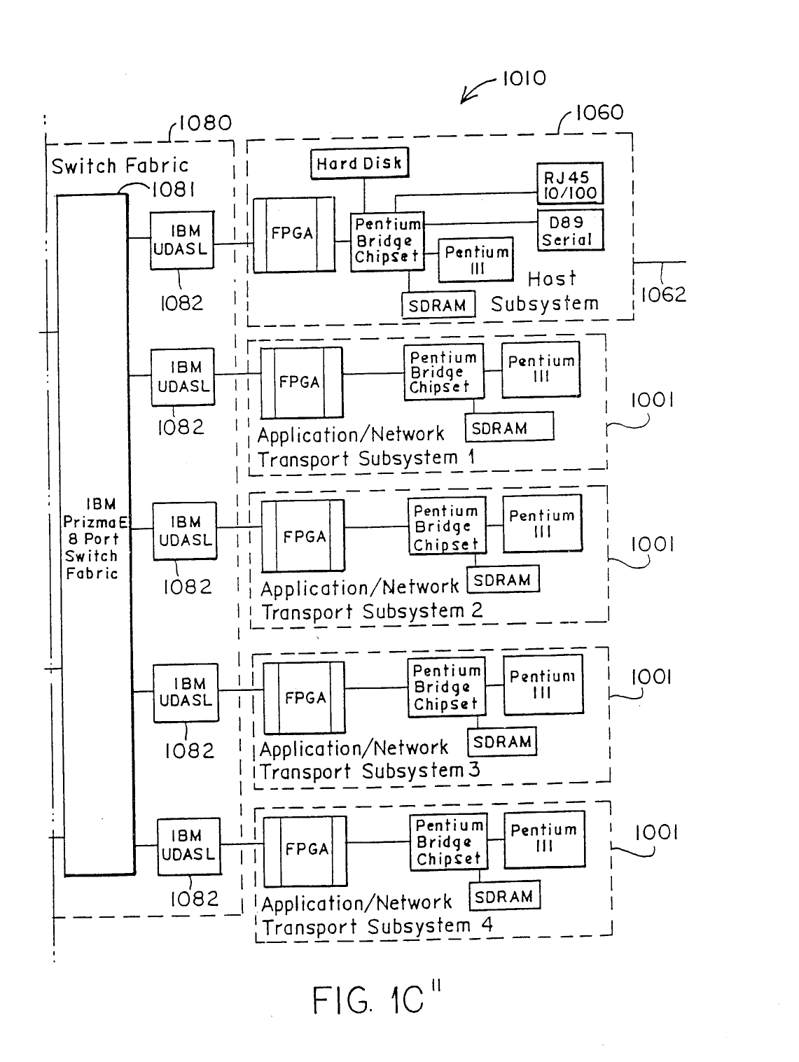

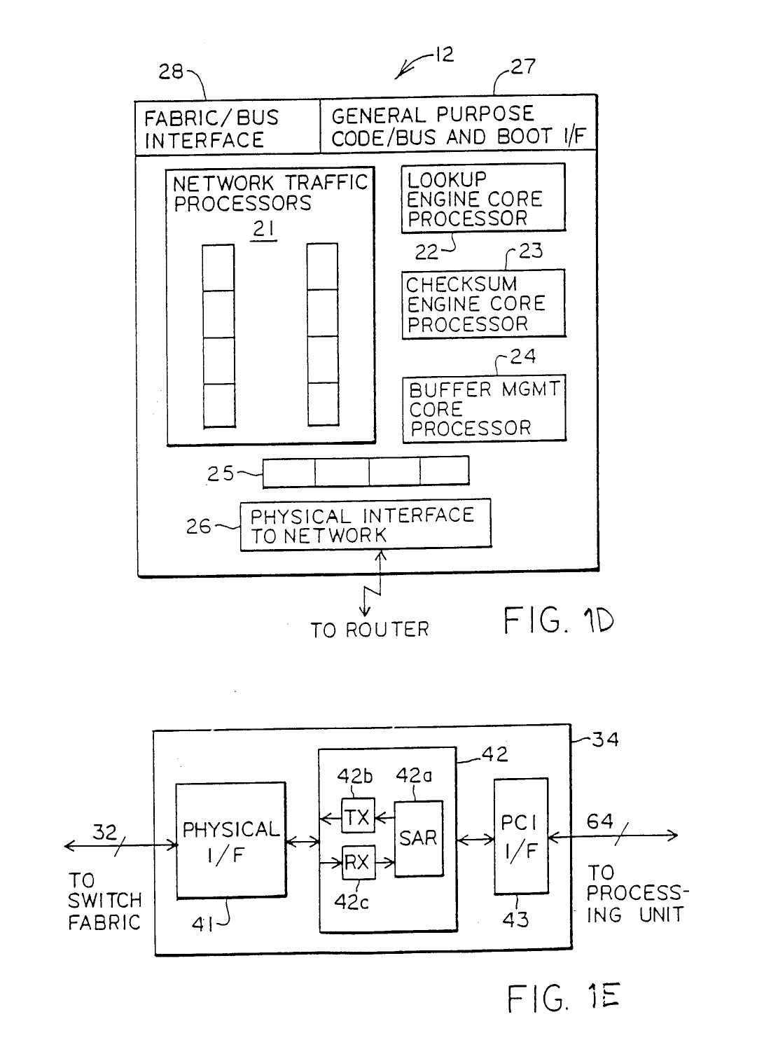

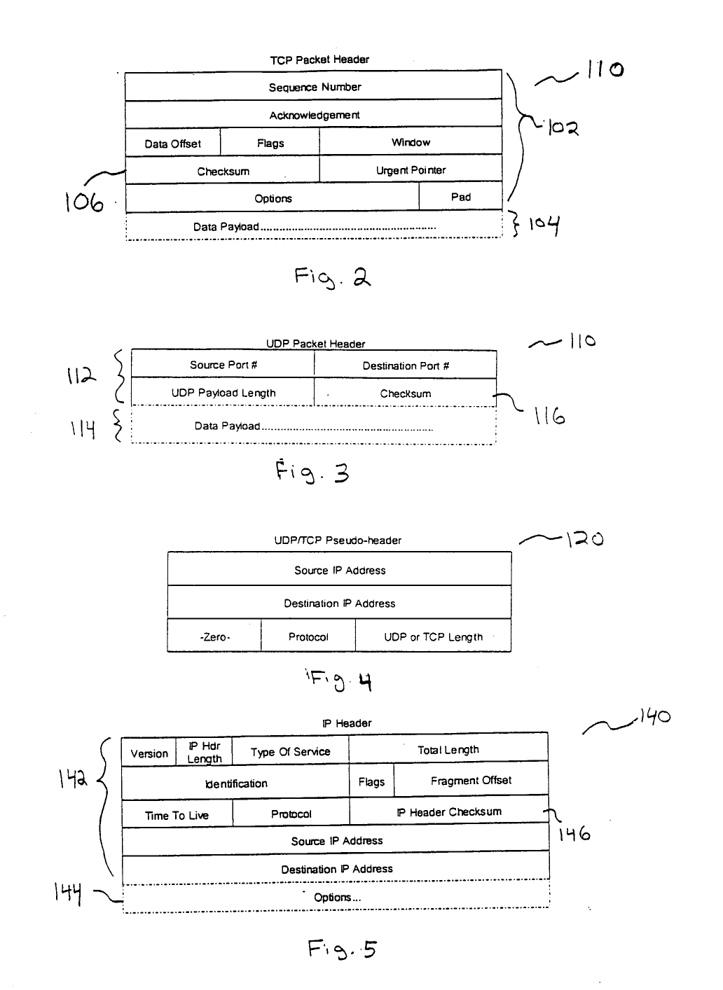

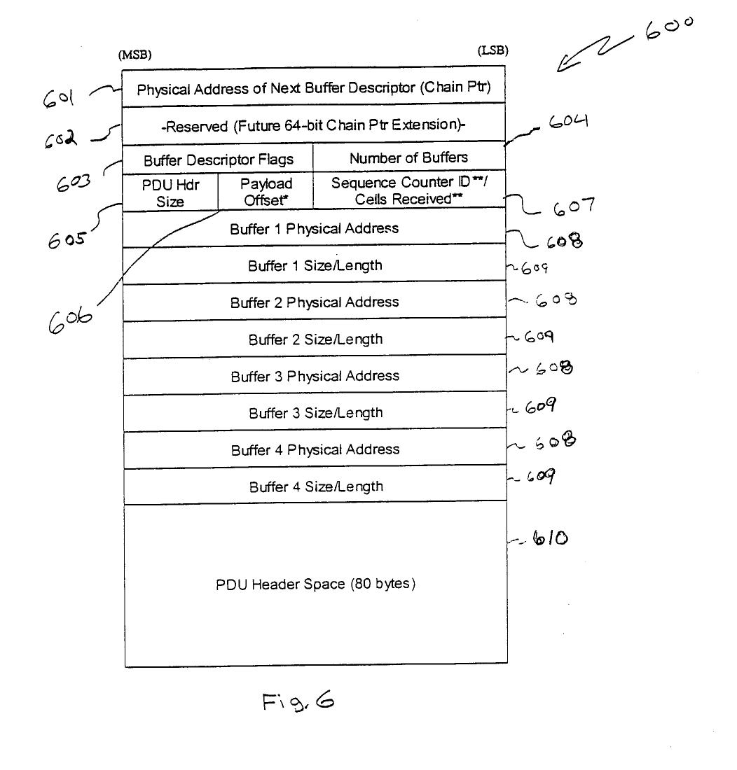

FIG. 1A is a representation of one embodiment of a content delivery system 1010, for example as may be employed as a network endpoint system in connection with a network 1020. Network 1020 may be any type of computer network suitable for linking computing systems. Content delivery system 1010 may be coupled to one or more networks including, but not limited to, the public internet, a private intranet network (e.g., linking users and hosts such as employees of a corporation or institution), a wide area network (WAN), a local area network (LAN), a wireless network, any other client based network or any other network environment of connected computer systems or online users. Thus, the data provided from the network 1020 may be in any networking protocol. In one embodiment, network 1020 may be the public internet that serves to provide access to content delivery system 1010 by multiple online users that utilize internet web browsers on personal computers operating through an internet service provider. In this case the data is assumed to follow one or more of various Internet Protocols, such as TCP/IP, UDP/IP, HTTP, RTSP, SSL, FTP, etc. However, the same concepts apply to networks using other existing or future protocols, such as IPX, SNMP, NetBios, Ipv6, etc. The concepts may also apply to file protocols such as network file system (NFS) or common internet file system (CIFS) file sharing protocol.

Examples of content that may be delivered by content delivery system 1010 include, but are not limited to, static content (e.g., web pages, MP3 files, HTTP object files, audio stream files, video stream files, etc.), dynamic content, etc. In this regard, static content may be defined as content available to content delivery system 1010 via attached storage devices and as content that does not generally require any processing before delivery. Dynamic content, on the other hand, may be defined as content that either requires processing before delivery, or resides remotely from content delivery system 1010. As illustrated in FIG. 1A, content sources may include, but are not limited to, one or more storage devices 1090 (magnetic disks, optical disks, tapes, storage area networks (SAN's), etc.), other content sources 1100, third party remote content feeds, broadcast sources (live direct audio or video broadcast feeds, etc.), delivery of cached content, combinations thereof, etc. Broadcast or remote content may be advantageously received through second network connection 1023 and delivered to network 1020 via an accelerated flowpath through content delivery system 1010. As discussed below, second network connection 1023 may be connected to a second network 1024 (as shown). Alternatively, both network connections 1022 and 1023 may be connected to network 1020.

As shown in FIG. 1A, one embodiment of content delivery system 1010 includes multiple system engines 1030, 1040, 1050, 1060, and 1070 communicatively coupled via distributive interconnection 1080. In the exemplary embodiment provided, these system engines operate as content delivery engines. As used herein, “content delivery engine” generally includes any hardware, software or hardware/software combination capable of performing one or more dedicated tasks or sub-tasks associated with the delivery or transmittal of content from one or more content sources to one or more networks. In the embodiment illustrated in FIG. 1A content delivery processing engines (or “processing blades”) include network interface processing engine 1030, storage processing engine 1040, network transport/protocol processing engine 1050 (referred to hereafter as a transport processing engine), system management processing engine 1060, and application processing engine 1070. Thus configured, content delivery system 1010 is capable of providing multiple dedicated and independent processing engines that are optimized for networking, storage and application protocols, each of which is substantially self-contained and therefore capable of functioning without consuming resources of the remaining processing engines.

It will be understood with benefit of this disclosure that the particular number and identity of content delivery engines illustrated in FIG. 1A are illustrative only, and that for any given content delivery system 1010 the number and/or identity of content delivery engines may be varied to fit particular needs of a given application or installation. Thus, the number of engines employed in a given content delivery system may be greater or fewer in number than illustrated in FIG. 1A, and/or the selected engines may include other types of content delivery engines and/or may not include all of the engine types illustrated in FIG. 1A. In one embodiment, the content delivery system 1010 may be implemented within a single chassis, such as for example, a 2U chassis.

Content delivery engines 1030, 1040, 1050, 1060 and 1070 are present to independently perform selected sub-tasks associated with content delivery from content sources 1090 and/or 1100, it being understood however that in other embodiments any one or more of such subtasks may be combined and performed by a single engine, or subdivided to be performed by more than one engine. In one embodiment, each of engines 1030, 1040, 1050, 1060 and 1070 may employ one or more independent processor modules (e.g., CPU modules) having independent processor and memory subsystems and suitable for performance of a given function/s, allowing independent operation without interference from other engines or modules. Advantageously, this allows custom selection of particular processor-types based on the particular sub-task each is to perform, and in consideration of factors such as speed or efficiency in performance of a given subtask, cost of individual processor, etc. The processors utilized may be any processor suitable for adapting to endpoint processing. Any “PC on a board” type device may be used, such as the ×86 and Pentium processors from Intel Corporation, the SPARC processor from Sun Microsystems, Inc., the PowerPC processor from Motorola, Inc. or any other microcontroller or microprocessor. In addition, network processors (discussed in more detail below) may also be utilized. The modular multi-task configuration of content delivery system 1010 allows the number and/or type of content delivery engines and processors to be selected or varied to fit the needs of a particular application.

The configuration of the content delivery system described above provides scalability without having to scale all the resources of a system. Thus, unlike the traditional rack and stack systems, such as server systems in which an entire server may be added just to expand one segment of system resources, the content delivery system allows the particular resources needed to be the only expanded resources. For example, storage resources may be greatly expanded without having to expand all of the traditional server resources.

Distributive Interconnect

Still referring to FIG. 1A, distributive interconnection 1080 may be any multi-node I/O interconnection hardware or hardware/software system suitable for distributing functionality by selectively interconnecting two or more content delivery engines of a content delivery system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, S-Bus, Microchannel, VME, etc. Generally, for purposes of this description, a “bus” is any system bus that carries data in a manner that is visible to all nodes on the bus. Generally, some sort of bus arbitration scheme is implemented and data may be carried in parallel, as n-bit words. As distinguished from a bus, a switch fabric establishes independent paths from node to node and data is specifically addressed to a particular node on the switch fabric. Other nodes do not see the data nor are they blocked from creating their own paths. The result is a simultaneous guaranteed bit rate in each direction for each of the switch fabric's ports.

The use of a distributed interconnect 1080 to connect the various processing engines in lieu of the network connections used with the switches of conventional multi-server endpoints is beneficial for several reasons. As compared to network connections, the distributed interconnect 1080 is less error prone, allows more deterministic content delivery, and provides higher bandwidth connections to the various processing engines. The distributed interconnect 1080 also has greatly improved data integrity and throughput rates as compared to network connections.

Use of the distributed interconnect 1080 allows latency between content delivery engines to be short, finite and follow a known path. Known maximum latency specifications are typically associated with the various bus architectures listed above. Thus, when the employed interconnect medium is a bus, latencies fall within a known range. In the case of a switch fabric, latencies are fixed. Further, the connections are “direct”, rather than by some undetermined path. In general, the use of the distributed interconnect 1080 rather than network connections, permits the switching and interconnect capacities of the content delivery system 1010 to be predictable and consistent.

One example interconnection system suitable for use as distributive interconnection 1080 is an 8/16 port 28.4 Gbps high speed PRIZMA-E non-blocking switch fabric switch available from IBM. It will be understood that other switch fabric configurations having greater or lesser numbers of ports, throughput, and capacity are also possible. Among the advantages offered by such a switch fabric interconnection in comparison to shared-bus interface interconnection technology are throughput, scalability and fast and efficient communication between individual discrete content delivery engines of content delivery system 1010. In the embodiment of FIG. 1A, distributive interconnection 1080 facilitates parallel and independent operation of each engine in its own optimized environment without bandwidth interference from other engines, while at the same time providing peer-to-peer communication between the engines on an as-needed basis (e.g., allowing direct communication between any two content delivery engines 1030, 1040, 1050, 1060 and 1070). Moreover, the distributed interconnect may directly transfer inter-processor communications between the various engines of the system. Thus, communication, command and control information may be provided between the various peers via the distributed interconnect. In addition, communication from one peer to multiple peers may be implemented through a broadcast communication which is provided from one peer to all peers coupled to the interconnect. The interface for each peer may be standardized, thus providing ease of design and allowing for system scaling by providing standardized ports for adding additional peers.

Network Interface Processing Engine

As illustrated in FIG. 1A, network interface processing engine 1030 interfaces with network 1020 by receiving and processing requests for content and delivering requested content to network 1020. Network interface processing engine 1030 may be any hardware or hardware/software subsystem suitable for connections utilizing TCP (Transmission Control Protocol) IP (Internet Protocol), UDP (User Datagram Protocol), RTP (Real-Time Transport Protocol), Wireless Application Protocol (WAP) as well as other networking protocols. Thus the network interface processing engine 1030 may be suitable for handling queue management, buffer management, TCP connect sequence, checksum, IP address lookup, internal load balancing, packet switching, etc. Thus, network interface processing engine 1030 may be employed as illustrated to process or terminate one or more layers of the network protocol stack and to perform look-up intensive operations, offloading these tasks from other content delivery processing engines of content delivery system 1010. Network interface processing engine 1030 may also be employed to load balance among other content delivery processing engines of content delivery system 1010. Both of these features serve to accelerate content delivery, and are enhanced by placement of distributive interchange and protocol termination processing functions on the same board. Examples of other functions that may be performed by network interface processing engine 1030 include, but are not limited to, security processing.

With regard to the network protocol stack, the stack in traditional systems may often be rather large. Processing the entire stack for every request across the distributed interconnect may significantly impact performance. As described herein, the protocol stack has been segmented or “split” between the network interface engine and the transport processing engine. An abbreviated version of the protocol stack is then provided across the interconnect. By utilizing this functionally split version of the protocol stack, increased bandwidth may be obtained. In this manner the communication and data flow through the content delivery system 1010 may be accelerated. The use of a distributed interconnect (for example a switch fabric) further enhances this acceleration as compared to traditional bus interconnects.

The network interface processing engine 1030 may be coupled to the network 1020 through a Gigabit (Gb) Ethernet fiber front end interface 1022. One or more additional Gb Ethernet interfaces 1023 may optionally be provided, for example, to form a second interface with network 1020, or to form an interface with a second network or application 1024 as shown (e.g., to form an interface with one or more server/s for delivery of web cache content, etc.). Regardless of whether the network connection is via Ethernet, or some other means, the network connection could be of any type, with other examples being ATM, SONET, or wireless. The physical medium between the network and the network processor may be copper, optical fiber, wireless, etc.

In one embodiment, network interface processing engine 1030 may utilize a network processor, although it will be understood that in other embodiments a network processor may be supplemented with or replaced by a general purpose processor or an embedded microcontroller. The network processor may be one of the various types of specialized processors that have been designed and marketed to switch network traffic at intermediate nodes. Consistent with this conventional application, these processors are designed to process high speed streams of network packets. In conventional operation, a network processor receives a packet from a port, verifies fields in the packet header, and decides on an outgoing port to which it forwards the packet. The processing of a network processor may be considered as “pass through” processing, as compared to the intensive state modification processing performed by general purpose processors. A typical network processor has a number of processing elements, some operating in parallel and some in pipeline. Often a characteristic of a network processor is that it may hide memory access latency needed to perform lookups and modifications of packet header fields. A network processor may also have one or more network interface controllers, such as a gigabit Ethernet controller, and are generally capable of handling data rates at “wire speeds”.

Examples of network processors include the C-Port processor manufactured by Motorola, Inc., the IXP1200 processor manufactured by Intel Corporation, the Prism processor manufactured by SiTera Inc., and others manufactured by MMC Networks, Inc. and Agere, Inc. These processors are programmable, usually with a RISC or augmented RISC instruction set, and are typically fabricated on a single chip.

The processing cores of a network processor are typically accompanied by special purpose cores that perform specific tasks, such as fabric interfacing, table lookup, queue management, and buffer management. Network processors typically have their memory management optimized for data movement, and have multiple I/O and memory buses. The programming capability of network processors permit them to be programmed for a variety of tasks, such as load balancing, network protocol processing, network security policies, and QoS/CoS support. These tasks can be tasks that would otherwise be performed by another processor. For example, TCP/IP processing may be performed by a network processor at the front end of an endpoint system. Another type of processing that could be offloaded is execution of network security policies or protocols. A network processor could also be used for load balancing. Network processors used in this manner can be referred to as “network accelerators” because their front end “look ahead” processing can vastly increase network response speeds. Network processors perform look ahead processing by operating at the front end of the network endpoint to process network packets in order to reduce the workload placed upon the remaining endpoint resources. Various uses of network accelerators are described in the following concurrently filed U.S. patent applications: Ser. No. 09/797,412, entitled “Network Transport Accelerator,” by Bailey et. al; Ser. No. 09/797,507 entitled “Single Chassis Network Endpoint System With Network Processor For Load Balancing,” by Richter et. al; and Ser. No. 09/797,411 entitled “Network Security Accelerator,” by Canion et. al; the disclosures of which are all incorporated herein by reference. When utilizing network processors in an endpoint environment it may be advantageous to utilize techniques for order serialization of information, such as for example, as disclosed in concurrently filed U.S. patent application Ser. No. 09/797.197, entitled “Methods and Systems For The Order Serialization Of Information In A Network Processing Environment,” by Richter et. al, the disclosure of which is incorporated herein by reference.

FIG. 1D illustrates one possible general configuration of a network processor. As illustrated, a set of traffic processors 21 operate in parallel to handle transmission and receipt of network traffic. These processors may be general purpose microprocessors or state machines. Various core processors 22-24 handle special tasks. For example, the core processors 22-24 may handle lookups, checksums, and buffer management. A set of serial data processors 25 provide Layer 1 network support. Interface 26 provides the physical interface to the network 1020. A general purpose bus interface 27 is used for downloading code and configuration tasks. A specialized interface 28 may be specially programmed to optimize the path between network processor 12 and distributed interconnection 1080.

As mentioned above, the network processors utilized in the content delivery system 1010 are utilized for endpoint use, rather than conventional use at intermediate network nodes. In one embodiment, network interface processing engine 1030 may utilize a MOTOROLA C-Port C-5 network processor capable of handling two Gb Ethernet interfaces at wire speed, and optimized for cell and packet processing. This network processor may contain sixteen 200 MHz MIPS processors for cell/packet switching and thirty-two serial processing engines for bit/byte processing, checksum generation/verification, etc. Further processing capability may be provided by five co-processors that perform the following network specific tasks: supervisor/executive, switch fabric interface, optimized table lookup, queue management, and buffer management. The network processor may be coupled to the network 1020 by using a VITESSE GbE SERDES (serializer-deserializer) device (for example the VSC7123) and an SFP (small form factor pluggable) optical transceiver for LC fiber connection.

Transport/Protocol Processing Engine

Referring again to FIG. 1A, transport processing engine 1050 may be provided for performing network transport protocol sub-tasks, such as processing content requests received from network interface engine 1030. Although named a “transport” engine for discussion purposes, it will be recognized that the engine 1050 performs transport and protocol processing and the term transport processing engine is not meant to limit the functionality of the engine. In this regard transport processing engine 1050 may be any hardware or hardware/software subsystem suitable for TCP/UDP processing, other protocol processing, transport processing, etc. In one embodiment transport engine 1050 may be a dedicated TCP/UDP processing module based on an INTEL PENTIUM III or MOTOROLA POWERPC 7450 based processor running the Thread-X RTOS environment with protocol stack based on TCP/IP technology.

As compared to traditional server type computing systems, the transport processing engine 1050 may off-load other tasks that traditionally a main CPU may perform. For example, the performance of server CPUs significantly decreases when a large amount of network connections are made merely because the server CPU regularly checks each connection for time outs. The transport processing engine 1050 may perform time out checks for each network connection, connection setup and tear-down, session management, data reordering and retransmission, data queueing and flow control, packet header generation, etc. off-loading these tasks from the application processing engine or the network interface processing engine. The transport processing engine 1050 may also handle error checking, likewise freeing up the resources of other processing engines.

Network Interface/Transport Split Protocol

The embodiment of FIG. 1A contemplates that the protocol processing is shared between the transport processing engine 1050 and the network interface engine 1030. This sharing technique may be called “split protocol stack” processing. The division of tasks may be such that higher tasks in the protocol stack are assigned to the transport processor engine. For example, network interface engine 1030 may processes all or some of the TCP/IP protocol stack as well as all protocols lower on the network protocol stack. Another approach could be to assign state modification intensive tasks to the transport processing engine.

In one embodiment related to a content delivery system that receives packets, the network interface engine performs the MAC header identification and verification, IP header identification and verification, IP header checksum validation, TCP and UDP header identification and validation, and TCP or UDP checksum validation. It also may perform the lookup to determine the TCP connection or UDP socket (protocol session identifier) to which a received packet belongs. Thus, the network interface engine verifies packet lengths, checksums, and validity. For transmission of packets, the network interface engine performs TCP or UDP checksum generation using the algorithm referenced herein, IP header generation, and MAC header generation, IP checksum generation, MAC FCS/CRC generation, etc.

Tasks such as those described above can all be performed rapidly by the parallel and pipeline processors within a network processor. The “fly by” processing style of a network processor permits it to look at each byte of a packet as it passes through, using registers and other alternatives to memory access. The network processor's “stateless forwarding” operation is best suited for tasks not involving complex calculations that require rapid updating of state information.

An appropriate internal protocol may be provided for exchanging information between the network interface engine 1030 and the transport engine 1050 when setting up or terminating a TCP and/or UDP connections and to transfer packets between the two engines. For example, where the distributive interconnection medium is a switch fabric, the internal protocol may be implemented as a set of messages exchanged across the switch fabric. These messages indicate the arrival of new inbound or outbound connections and contain inbound or outbound packets on existing connections, along with identifiers or tags for those connections. The internal protocol may also be used to transfer identifiers or tags between the transport engine 1050 and the application processing engine 1070 and/or the storage processing engine 1040. These identifiers or tags may be used to reduce or strip or accelerate a portion of the protocol stack.

For example, with a TCP/IP connection, the network interface engine 1030 may receive a request for a new connection. The header information associated with the initial request may be provided to the transport processing engine 1050 for processing. That result of this processing may be stored in the resources of the transport processing engine 1050 as state and management information for that particular network session. The transport processing engine 1050 then informs the network interface engine 1030 as to the location of these results. Subsequent packets related to that connection that are processed by the network interface engine 1030 may have some of the header information stripped and replaced with an identifier or tag that is provided to the transport processing engine 1050. The identifier or tag may be a pointer, index or any other mechanism that provides for the identification of the location in the transport processing engine of the previously setup state and management information (or the corresponding network session). In this manner, the transport processing engine 1050 does not have to process the header information of every packet of a connection. Rather, the transport interface engine merely receives a contextually meaningful identifier or tag that identifies the previous processing results for that connection.

In one embodiment, the data link, network, transport and session layers (layers 2-5) of a packet may be replaced by identifier or tag information. For packets related to an established connection the transport processing engine does not have to perform intensive processing with regard to these layers such as hashing, scanning, look up, etc. operations. Rather, these layers have already been converted (or processed) once in the transport processing engine and the transport processing engine just receives the identifier or tag provided from the network interface engine that identifies the location of the conversion results.

In this manner an identifier or tag is provided for each packet of an established connection so that the more complex data computations of converting header information may be replaced with a more simplistic analysis of an identifier or tag. The delivery of content is thereby accelerated, as the time for packet processing and the amount of system resources for packet processing are both reduced. The functionality of network processors, which provide efficient parallel processing of packet headers, is well suited for enabling the acceleration described herein. In addition, acceleration is further provided as the physical size of the packets provided across the distributed interconnect may be reduced.

Though described herein with reference to messaging between the network interface engine and the transport processing engine, the use of identifiers or tags may be utilized amongst all the engines in the modular pipelined processing described herein. Thus, one engine may replace packet or data information with contextually meaningful information that may require less processing by the next engine in the data and communication flow path. In addition, these techniques may be utilized for a wide variety of protocols and layers, not just the exemplary embodiments provided herein.

With the above-described tasks being performed by the network interface engine, the transport engine may perform TCP sequence number processing, acknowledgement and retransmission, segmentation and reassembly, and flow control tasks. These tasks generally call for storing and modifying connection state information on each TCP and UDP connection, and therefore are considered more appropriate for the processing capabilities of general purpose processors.

As will be discussed with references to alternative embodiments (such as FIGS. 2 and 2A), the transport engine 1050 and the network interface engine 1030 may be combined into a single engine. Such a combination may be advantageous as communication across the switch fabric is not necessary for protocol processing. However, limitations of many commercially available network processors make the split protocol stack processing described above desirable.

Application Processing Engine

Application processing engine 1070 may be provided in content delivery system 1010 for application processing, and may be, for example, any hardware or hardware/software subsystem suitable for session layer protocol processing (e.g., HTTP, RTSP streaming, etc.) of content requests received from network transport processing engine 1050. In one embodiment application processing engine 1070 may be a dedicated application processing module based on an INTEL PENTIUM III processor running, for example, on standard x86 OS systems (e.g., Linux, Windows NT, FreeBSD, etc.). Application processing engine 1070 may be utilized for dedicated application-only processing by virtue of the off-loading of all network protocol and storage processing elsewhere in content delivery system 1010. In one embodiment, processor programming for application processing engine 1070 may be generally similar to that of a conventional server, but without the tasks off-loaded to network interface processing engine 1030, storage processing engine 1040, and transport processing engine 1050.

Storage Management Engine

Storage management engine 1040 may be any hardware or hardware/software subsystem suitable for effecting delivery of requested content from content sources (for example content sources 1090 and/or 1100) in response to processed requests received from application processing engine 1070. It will also be understood that in various embodiments a storage management engine 1040 may be employed with content sources other than disk drives (e.g., solid state storage, the storage systems described above, or any other media suitable for storage of data) and may be programmed to request and receive data from these other types of storage.

In one embodiment, processor programming for storage management engine 1040 may be optimized for data retrieval using techniques such as caching, and may include and maintain a disk cache to reduce the relatively long time often required to retrieve data from content sources, such as disk drives. Requests received by storage management engine 1040 from application processing engine 1070 may contain information on how requested data is to be formatted and its destination, with this information being comprehensible to transport processing engine 1050 and/or network interface processing engine 1030. The storage management engine 1040 may utilize a disk cache to reduce the relatively long time it may take to retrieve data stored in a storage medium such as disk drives. Upon receiving a request, storage management engine 1040 may be programmed to first determine whether the requested data is cached, and then to send a request for data to the appropriate content source 1090 or 1100. Such a request may be in the form of a conventional read request. The designated content source 1090 or 1100 responds by sending the requested content to storage management engine 1040, which in turn sends the content to transport processing engine 1050 for forwarding to network interface processing engine 1030.

Based on the data contained in the request received from application processing engine 1070, storage processing engine 1040 sends the requested content in proper format with the proper destination data included. Direct communication between storage processing engine 1040 and transport processing engine 1050 enables application processing engine 1070 to be bypassed with the requested content. Storage processing engine 1040 may also be configured to write data to content sources 1090 and/or 1100 (e.g., for storage of live or broadcast streaming content).

In one embodiment storage management engine 1040 may be a dedicated block-level cache processor capable of block level cache processing in support of thousands of concurrent multiple readers, and direct block data switching to network interface engine 1030. In this regard storage management engine 1040 may utilize a POWER PC 7450 processor in conjunction with ECC memory and a LSI SYMFC929 dual 2GBaud fibre channel controller for fibre channel interconnect to content sources 1090 and/or 1100 via dual fibre channel arbitrated loop 1092. It will be recognized, however, that other forms of interconnection to storage sources suitable for retrieving content are also possible. Storage management engine 1040 may include hardware and/or software for running the Fibre Channel (FC) protocol, the SCSI (Small Computer Systems Interface) protocol, iSCSI protocol as well as other storage networking protocols.

Storage management engine 1040 may employ any suitable method for caching data, including simple computational caching algorithms such as random removal (RR), first-in first-out (FIFO), predictive read-ahead, over buffering, etc. algorithms. Other suitable caching algorithms include those that consider one or more factors in the manipulation of content stored within the cache memory, or which employ multi-level ordering, key based ordering or function based calculation for replacement. In one embodiment, storage management engine may implement a layered multiple LRU (LMLRU) algorithm that uses an integrated block/buffer management structure including at least two layers of a configurable number of multiple LRU queues and a two-dimensional positioning algorithm for data blocks in the memory to reflect the relative priorities of a data block in the memory in terms of both recency and frequency. Such a caching algorithm is described in further detail in concurrently filed U.S. patent application Ser. No. 09/797,198, entitled “Systems and Methods for Management of Memory” by Qiu et. al, the disclosure of which is incorporated herein by reference.

For increasing delivery efficiency of continuous content, such as streaming multimedia content, storage management engine 1040 may employ caching algorithms that consider the dynamic characteristics of continuous content. Suitable examples include, but are not limited to, interval caching algorithms. In one embodiment, improved caching performance of continuous content may be achieved using an LMLRU caching algorithm that weighs ongoing viewer cache value versus the dynamic time-size cost of maintaining particular content in cache memory. Such a caching algorithm is described in further detail in concurrently filed U.S. patent application Ser. No. 09/797,201, entitled “Systems and Methods for Management of Memory in Information Delivery Environments” by Qiu et. al, the disclosure of which is incorporated herein by reference.

System Management Engine

System management (or host) engine 1060 may be present to perform system management functions related to the operation of content delivery system 1010. Examples of system management functions include, but are not limited to, content provisioning/updates, comprehensive statistical data gathering and logging for sub-system engines, collection of shared user bandwidth utilization and content utilization data that may be input into billing and accounting systems, “on the fly” ad insertion into delivered content, customer programmable sub-system level quality of service (“QoS”) parameters, remote management (e.g., SNMP, web-based, CLI), health monitoring, clustering controls, remote/local disaster recovery functions, predictive performance and capacity planning, etc. In one embodiment, content delivery bandwidth utilization by individual content suppliers or users (e.g., individual supplier/user usage of distributive interchange and/or content delivery engines) may be tracked and logged by system management engine 1060, enabling an operator of the content delivery system 1010 to charge each content supplier or user on the basis of content volume delivered.

System management engine 1060 may be any hardware or hardware/software subsystem suitable for performance of one or more such system management engines and in one embodiment may be a dedicated application processing module based, for example, on an INTEL PENTIUM III processor running an ×86 OS. Because system management engine 1060 is provided as a discrete modular engine, it may be employed to perform system management functions from within content delivery system 1010 without adversely affecting the performance of the system. Furthermore, the system management engine 1060 may maintain information on processing engine assignment and content delivery paths for various content delivery applications, substantially eliminating the need for an individual processing engine to have intimate knowledge of the hardware it intends to employ.

Under manual or scheduled direction by a user, system management processing engine 1060 may retrieve content from the network 1020 or from one or more external servers on a second network 1024 (e.g., LAN) using, for example, network file system (NFS) or common internet file system (CIFS) file sharing protocol. Once content is retrieved, the content delivery system may advantageously maintain an independent copy of the original content, and therefore is free to employ any file system structure that is beneficial, and need not understand low level disk formats of a large number of file systems.

Management interface 1062 may be provided for interconnecting system management engine 1060 with a network 1200 (e.g., LAN), or connecting content delivery system 1010 to other network appliances such as other content delivery systems 1010, servers, computers, etc. Management interface 1062 may be by any suitable.,network interface, such as 10/100 Ethernet, and may support communications such as management and origin traffic. Provision for one or more terminal management interfaces (not shown) for may also be provided, such as by RS-232 port, etc. The management interface may be utilized as a secure port to provide system management and control information to the content delivery system 1010. For example, tasks which may be accomplished through the management interface 1062 include reconfiguration of the allocation of system hardware (as discussed below with reference to FIGS. 1C-1F), programming the application processing engine, diagnostic testing, and any other management or control tasks. Though generally content is not envisioned being provided through the management interface, the identification of or location of files or systems containing content may be received through the management interface 1062 so that the content delivery system may access the content through the other higher bandwidth interfaces.

Management Performed by the Network Inteface

Some of the system management functionality may also be performed directly within the network interface processing engine 1030. In this case some system policies and filters may be executed by the network interface engine 1030 in real-time at wirespeed. These polices and filters may manage some traffic/bandwidth management criteria and various service level guarantee policies. Examples of such system management functionality of are described below. It will be recognized that these functions may be performed by the system management engine 1060, the network interface engine 1030, or a combination thereof.

For example, a content delivery system may contain data for two web sites. An operator of the content delivery system may guarantee one web site (“the higher quality site”) higher performance or bandwidth than the other web site (“the lower quality site”), presumably in exchange for increased compensation from the higher quality site. The network interface processing engine 1030 may be utilized to determine if the bandwidth limits for the lower quality site have been exceeded and reject additional data requests related to the lower quality site. Alternatively, requests related to the lower quality site may be rejected to ensure the guaranteed performance of the higher quality site is achieved. In this manner the requests may be rejected immediately at the interface to the external network and additional resources of the content delivery system need not be utilized. In another example, storage service providers may use the content delivery system to charge content providers based on system bandwidth of downloads (as opposed to the traditional storage area based fees). For billing purposes, the network interface engine may monitor the bandwidth use related to a content provider. The network interface engine may also reject additional requests related to content from a content provider whose bandwidth limits have been exceeded. Again, in this manner the requests may be rejected immediately at the interface to the external network and additional resources of the content delivery system need not be utilized.

Additional system management functionality, such as quality of service (QoS) functionality, also may be performed by the network interface engine. A request from the external network to the content delivery system may seek a specific file and also may contain Quality of Service (QoS) parameters. In one example, the QoS parameter may indicate the priority of service that a client on the external network is to receive. The network interface engine may recognize the QoS data and the data may then be utilized when managing the data and communication flow through the content delivery system. The request may be transferred to the storage management engine to access this file via a read queue, e.g., [Destination IP][Filename][File Type (CoS)][Transport Priorities (QoS)]. All file read requests may be stored in a read queue. Based on CoS/QoS policy parameters as well as buffer status within the storage management engine (empty, full, near empty, block seq#, etc), the storage management engine may prioritize which blocks of which files to access from the disk next, and transfer this data into the buffer memory location that has been assigned to be transmitted to a specific IP address. Thus based upon QoS data in the request provided to the content delivery system, the data and communication traffic through the system may be prioritized. The QoS and other policy priorities may be applied to both incoming and outgoing traffic flow. Therefore a request having a higher QoS priority may be received after a lower order priority request, yet the higher priority request may be served data before the lower priority request.

The network interface engine may also be used to filter requests that are not supported by the content delivery system. For example, if a content delivery system is configured only to accept HTTP requests, then other requests such as FTP, telnet, etc. may be rejected or filtered. This filtering may be applied directly at the network interface engine, for example by programming a network processor with the appropriate system policies. Limiting undesirable traffic directly at the network interface offloads such functions from the other processing modules and improves system performance by limiting the consumption of system resources by the undesirable traffic. It will be recognized that the filtering example described herein is merely exemplary and many other filter criteria or policies may be provided.

Multi-Processor Moule Design

As illustrated in FIG. 1A, any given processing engine of content delivery system 1010 may be optionally provided with multiple processing modules so as to enable parallel or redundant processing of data and/or communications. For example, two or more individual dedicated TCP/UDP processing modules 1050a and 1050b may be provided for transport processing engine 1050, two or more individual application processing modules 1070a and 1070b may be provided for network application processing engine 1070, two or more individual network interface processing modules 1030a and 1030b may be provided for network interface processing engine 1030 and two or more individual storage management processing modules 1040a and 1040b may be provided for storage management processing engine 1040. Using such a configuration, a first content request may be processed between a first TCP/UDP processing module and a first application processing module via a first switch fabric path, at the same time a second content request is processed between a second TCP/UDP processing module and a second application processing module via a second switch fabric path. Such parallel processing capability may be employed to accelerate content delivery.

Alternatively, or in combination with parallel processing capability, a first TCP/UDP processing module 1050a may be backed-up by a second TCP/UDP processing module 1050b that acts as an automatic failover spare to the first module 1050a. In those embodiments employing multiple-port switch fabrics, various combinations of multiple modules may be selected for use as desired on an individual system-need basis (e.g., as may be dictated by module failures and/or by anticipated or actual bottlenecks), limited only by the number of available ports in the fabric. This feature offers great flexibility in the operation of individual engines and discrete processing modules of a content delivery system, which may be translated into increased content delivery acceleration and reduction or substantial elimination of adverse effects resulting from system component failures.

In yet other embodiments, the processing modules may be specialized to specific applications, for example, for processing and delivering HTTP content, processing and delivering RTSP content, or other applications. For example, in such an embodiment an application processing module 1070a and storage processing module 1040a may be specially programmed for processing a first type of request received from a network. In the same system, application processing module 1070b and storage processing module 1040b may be specially programmed to handle a second type of request different from the first type. Routing of requests to the appropriate respective application and/or storage modules may be accomplished using a distributive interconnect and may be controlled by transport and/or interface processing modules as requests are received and processed by these modules using policies set by the system management engine.

Further, by employing processing modules capable of performing the function of more than one engine in a content delivery system, the assigned functionality of a given module may be changed on an as-needed basis, either manually or automatically by the system management engine upon the occurrence of given parameters or conditions. This feature may be achieved, for example, by using similar hardware modules for different content delivery engines (e.g., by employing PENTIUM III based processors for both network transport processing modules and for application processing modules), or by using different hardware modules capable of performing the same task as another module through software programmability (e.g., by employing a POWER PC processor based module for storage management modules that are also capable of functioning as network transport modules). In this regard, a content delivery system may be configured so that such functionality reassignments may occur during system operation, at system boot-up or in both cases. Such reassignments may be effected, for example, using software so that in a given content delivery system every content delivery engine (or at a lower level, every discrete content delivery processing module) is potentially dynamically reconfigurable using software commands. Benefits of engine or module reassignment include maximizing use of hardware resources to deliver content while minimizing the need to add expensive hardware to a content delivery system.

Thus, the system disclosed herein allows various levels of load balancing to satisfy a work request. At a system hardware level, the functionality of the hardware may be assigned in a manner that optimizes the system performance for a given load. At the processing engine level, loads may be balanced between the multiple processing modules of a given processing engine to further optimize the system performance.

Exemplary Data and Communication Flow Paths

FIG. 1B illustrates one exemplary data and communication flow path configuration among modules of one embodiment of content delivery system 1010. The flow paths shown in FIG. 1B are just one example given to illustrate the significant improvements in data processing capacity and content delivery acceleration that may be realized using multiple content delivery engines that are individually optimized for different layers of the software stack and that are distributively interconnected as disclosed herein. The illustrated embodiment of FIG. 1B employs two network application processing modules 1070a and 1070b, and two network transport processing modules 1050a and 1050b that are communicatively coupled with single storage management processing module 1040a and single network interface processing module 1030a. The storage management processing module 1040a is in turn coupled to content sources 1090 and 1100. In FIG. 1B, inter-processor command or control flow (i.e. incoming or received data request) is represented by dashed lines, and delivered content data flow is represented by solid lines. Command and data flow between modules may be accomplished through the distributive interconnection 1080 (not shown), for example a switch fabric.

As shown in FIG. 1B, a request for content is received and processed by network interface processing module 1030a and then passed on to either of network transport processing modules 1050a or 1050b for TCP/UDP processing, and then on to respective application processing modules 1070a or 1070b, depending on the transport processing module initially selected. After processing by the appropriate network application processing module, the request is passed on to storage management processor 1040a for processing and retrieval of the requested content from appropriate content sources 1090 and/or 1100. Storage management processing module 1040a then forwards the requested content directly to one of network transport processing modules 1050a or 1050b, utilizing the capability of distributive interconnection 1080 to bypass application processing modules 1070a and 1070b. The requested content may then be transferred via the network interface processing module 1030a to the external network 1020. Benefits of bypassing the application processing modules with the delivered content include accelerated delivery of the requested content and offloading of workload from the application processing modules, each of which translate into greater processing efficiency and content delivery throughput. In this regard, throughput is generally measured in sustained data rates passed through the system and may be measured in bits per second. Capacity may be measured in terms of the number of files that may be partially cached, the number of TCP/IP connections per second as well as the number of concurrent TCP/IP connections that may be maintained or the number of simultaneous streams of a certain bit rate. In an alternative embodiment, the content may be delivered from the storage management processing module to the application processing module rather than bypassing the application processing module. This data flow may be advantageous if additional processing of the data is desired. For example, it may be desirable to decode or encode the data prior to delivery to the network.

To implement the desired command and content flow paths between multiple modules, each module may be provided with means for identification, such as a component ID. Components may be affiliated with content requests and content delivery to effect a desired module routing. The data-request generated by the network interface engine may include pertinent information such as the component ID of the various modules to be utilized in processing the request. For example, included in the data request sent to the storage management engine may be the component ID of the transport engine that is designated to receive the requested content data. When the storage management engine retrieves the data from the storage device and is ready to send the data to the next engine, the storage management engine knows which component ID to send the data to.

As further illustrated in FIG. 1B, the use of two network transport modules in conjunction with two network application processing modules provides two parallel processing paths for network transport and network application processing, allowing simultaneous processing of separate content requests and simultaneous delivery of separate content through the parallel processing paths, further increasing throughput/capacity and accelerating content delivery. Any two modules of a given engine may communicate with separate modules of another engine or may communicate with the same module of another engine. This is illustrated in FIG. 1B where the transport modules are shown to communicate with separate application modules and the application modules are shown to communicate with the same storage management module.

FIG. 1B illustrates only one exemplary embodiment of module and processing flow path configurations that may be employed using the disclosed method and system. Besides the embodiment illustrated in FIG. 1B, it will be understood that multiple modules may be additionally or alternatively employed for one or more other network content delivery engines (e.g., storage management processing engine, network interface processing engine, system management processing engine, etc.) to create other additional or alternative parallel processing flow paths, and that any number of modules (e.g., greater than two) may be employed for a given processing engine or set of processing engines so as to achieve more than two parallel processing flow paths. For example, in other possible embodiments, two or more different network transport processing engines may pass content requests to the same application unit, or vice-versa.

Thus, in addition to the processing flow paths illustrated in FIG. 1B, it will be understood that the disclosed distributive interconnection system may be employed to create other custom or optimized processing flow paths (e.g., by bypassing and/or interconnecting any given number of processing engines in desired sequence/s) to fit the requirements or desired operability of a given content delivery application. For example, the content flow path of FIG. 1B illustrates an exemplary application in which the content is contained in content sources 1090 and/or 1100 that are coupled to the storage processing engine 1040. However as discussed above with reference to FIG. 1A, remote and/or live broadcast content may be provided to the content delivery system from the networks 1020 and/or 1024 via the second network interface connection 1023. In such a situation the content may be received by the network interface engine 1030 over interface connection 1023 and immediately re-broadcast over interface connection 1022 to the network 1020. Alternatively, content may be proceed through the network interface connection 1023 to the network transport engine 1050 prior to returning to the network interface engine 1030 for re-broadcast over interface connection 1022 to the network 1020 or 1024. In yet another alternative, if the content requires some manner of application processing (for example encoded content that may need to be decoded), the content may proceed all the way to the application engine 1070 for processing. After application processing the content may then be delivered through the network transport engine 1050, network interface engine 1030 to the network 1020 or 1024.

In yet another embodiment, at least two network interface modules 1030a and 1030b may be provided, as illustrated in FIG. 1A. In this embodiment, a first network interface engine 1030a may receive incoming data from a network and pass the data directly to the second network interface engine 1030b for transport back out to the same or different network. For example, in the remote or live broadcast application described above, first network interface engine 1030a may receive content, and second network interface engine 1030b provide the content to the network 1020 to fulfill requests from one or more clients for this content. Peer-to-peer level communication between the two network interface engines allows first network interface engine 1030a to send the content directly to second network interface engine 1030b via distributive interconnect 1080. If necessary, the content may also be routed through transport processing engine 1050, or through transport processing engine 1050 and application processing engine 1070, in a manner described above.

Still yet other applications may exist in which the content required to be delivered is contained both in the attached content sources 1090 or 1100 and at other remote content sources. For example in a web caching application, not all content may be cached in the attached content sources, but rather some data may also be cached remotely. In such an application, the data and communication flow may be a combination of the various flows described above for content provided from the content sources 1090 and 100 and for content provided from remote sources on the networks 1020 and/or 1024.

The content delivery system 1010 described above is configured in a peer-to-peer manner that allows the various engines and modules to communicate with each other directly as peers through the distributed interconnect. This is contrasted with a traditional server architecture in which there is a main CPU. Furthermore unlike the arbitrated bus of traditional servers, the distributed interconnect 1080 provides a switching means which is not arbitrated and allows multiple simultaneous communications between the various peers. The data and communication flow may by-pass unnecessary peers such as the return of data from the storage management processing engine 1040 directly to the network interface processing engine 1030 as described with reference to FIG. 1B.

Communications between the various processor engines may be made through the use of a standardized internal protocol. Thus, a standardized method is provided for routing through the switch fabric and communicating between any two of the processor engines which operate as peers in the peer to peer environment. The standardized internal protocol provides a mechanism upon which the external network protocols may “ride” upon or be incorporated within. In this manner additional internal protocol layers relating to internal communication and data exchange may be added to the external protocol layers. The additional internal layers may be provided in addition to the external layers or may replace some of the external protocol layers (for example as described above portions of the external headers may be replaced by identifiers or tags by the network interface engine).

The standardized internal protocol may consist of a system of message classes, or types, where the different classes can independently include fields or layers that are utilized to identify the destination processor engine or processor module for communication, control, or data messages provided to the switch fabric along with information pertinent to the corresponding message class. The standardized internal protocol may also include fields or layers that identify the priority that a data packet has within the content delivery system. These priority levels may be set by each processing engine based upon system-wide policies. Thus, some traffic within the content delivery system may be prioritized over other traffic and this priority level may be directly indicated within the internal protocol call scheme utilized to enable communications within the system. The prioritization helps enable the predictive traffic flow between engines and end-to-end through the system such that service level guarantees may be supported.

Other internally added fields or layers may include processor engine state, system timestamps, specific message class identifiers for message routing across the switch fabric and at the receiving processor engine(s), system keys for secure control message exchange, flow control information to regulate control and data traffic flow and prevent congestion, and specific address tag fields that allow hardware at the receiving processor engines to move specific types of data directly into system memory.

In one embodiment, the internal protocol may be structured as a set, or system of messages with common system defined headers that allows all processor engines and, potentially, processor engine switch fabric attached hardware, to interpret and process messages efficiently and intelligently. This type of design allows each processing engine, and specific functional entities within the processor engines, to have their own specific message classes optimized functionally for the exchanging their specific types control and data information. Some message classes that may be employed are: System Control messages for system management, Network Interface to Network Transport messages, Network Transport to Application Interface messages, File System to Storage engine messages, Storage engine to Network Transport messages, etc. Some of the fields of the standardized message header may include message priority, message class, message class identifier (subtype), message size, message options and qualifier fields, message context identifiers or tags, etc. In addition, the system statistics gathering, management and control of the various engines may be performed across the switch fabric connected system using the messaging capabilities.

By providing a standardized internal protocol, overall system performance may be improved. In particular, communication speed between the processor engines across the switch fabric may be increased. Further, communications between any two processor engines may be enabled. The standardized protocol may also be utilized to reduce the processing loads of a given engine by reducing the amount of data that may need to be processed by a given engine.

The internal protocol may also be optimized for a particular system application, providing further performance improvements. However, the standardized internal communication protocol may be general enough to support encapsulation of a wide range of networking and storage protocols. Further, while internal protocol may run on PCI, PCI-X, ATM, IB, Infiniband, HyperTransport, Lightning I/O, the internal protocol is a protocol above these transport-level standards and is optimal for use in a switched (non-bus) environment such as a switch fabric. In addition, the internal protocol may be utilized to communicate devices (or peers) connected to the system in addition to those described herein. For example, a peer need not be a processing engine. In one example, a peer may be an ASIC protocol converter that is coupled to the distributed interconnect as a peer but operates as a slave device to other master devices within the system. The internal protocol may also be as a protocol communicated between systems such as used in the clusters described above.

Thus a system has been provided in which the networking/server clustering/storage networking has been collapsed into a single system utilizing a common low-overhead internal communication protocol/transport system.

Content Delivery Acceleration

As described above, a wide range of techniques have been provided for accelerating content delivery from the content delivery system 1010 to a network. By accelerating the speed at which content may be delivered, a more cost effective and higher performance system may be provided. These techniques may be utilized separately or in various combinations.

One content acceleration technique involves the use of a multi-engine system with dedicated engines for varying processor tasks. Each engine can perform operations independently and in parallel with the other engines without the other engines needing to yield or halt operations. The engines do not have to compete for resources such as memory, I/O, processor time, etc. but are provided with their own resources. Each engine may also be tailored in hardware and/or software to perform specific content delivery task, thereby providing increasing content delivery speeds while requiring less system resources. Further, all data, regardless of the flow path, gets processed in a staged pipeline fashion such that each engine continues to process its layer of functionality after forwarding data to the next engine/layer.

Content acceleration is also obtained from the use of multiple processor modules within an engine. In this manner, parallelism may be achieved within a specific processing engine. Thus, multiple processors responding to different content requests may be operating in parallel within one engine.

Content acceleration is also provided by utilizing the multi-engine design in a peer to peer environment in which each engine may communicate as a peer. Thus, the communications and data paths may skip unnecessary engines. For example, data may be communicated directly from the storage processing engine to the transport processing engine without have to utilize resources of the application processing engine.

Acceleration of content delivery is also achieved by removing or stripping the contents of some protocol layers in one processing engine and replacing those layers with identifiers or tags for use with the next processor engine in the data or communications flow path. Thus, the processing burden placed on the subsequent engine may be reduced. In addition, the packet. size transmitted across the distributed interconnect may be reduced. Moreover, protocol processing may be off-loaded from the storage and/or application processors, thus freeing those resources to focus on storage or application processing.

Content acceleration is also provided by using network processors in a network endpoint system. Network processors generally are specialized to perform packet analysis functions at intermediate network nodes, but in the content delivery system disclosed the network processors have been adapted for endpoint functions. Furthermore, the parallel processor configurations within a network processor allow these endpoint functions to be performed efficiently.

In addition, content acceleration has been provided through the use of a distributed interconnection such as a switch fabric. A switch fabric allows for parallel communications between the various engines and helps to efficiently implement some of the acceleration techniques described herein.

It will be recognized that other aspects of the content delivery system 1010 also provide for accelerated delivery of content to a network connection. Further, it will be recognized that the techniques disclosed herein may be equally applicable to other network endpoint systems and even non-endpoint systems.

Exemplary Hardware Embodiments

FIG. 1C (shown on two sheets as FIGS. 1C′ and 1C″ and collectively referred to herein as 1C) illustrates a network content delivery engine configurations possible with one exemplary hardware embodiment of content delivery system 1010. In the illustrated configuration of this hardware embodiment, content delivery system 1010 includes processing modules that may be configured to operate as content delivery engines 1030, 1040, 1050, 1060, and 1070 communicatively coupled via distributive interconnection 1080. As shown in FIG. 1C, a single processor module may operate as the network interface processing engine 1030 and a single processor module may operate as the system management processing engine 1060. Four processor modules 1001 may be configured to operate as either the transport processing engine 1050 or the application processing engine 1070. Two processor modules 1003 may operate as either the storage processing engine 1040 or the transport processing engine 1050. The Gigabit (Gb) Ethernet front end interface 1022, system management interface 1062 and dual fibre channel arbitrated loop 1092 are also shown.

As mentioned above, the distributive interconnect 1080 may be a switch fabric based interconnect. As shown in FIG. 1C, the interconnect may be an IBM PRIZMA-E eight/sixteen port switch fabric 1081. In an eight port mode, this switch fabric is an 8×3.54 Gbps fabric and in a sixteen port mode, this switch fabric is a 16×1.77 Gbps fabric. The eight/sixteen port switch fabric may be utilized in an eight port mode for performance optimization. The switch fabric 1081 may be coupled to the individual processor modules through interface converter circuits 1082, such as IBM UDASL switch interface circuits. The interface converter circuits 1082 convert the data aligned serial link interface (DASL) to a UTOPIA (Universal Test and Operations PHY Interface for ATM) parallel interface. FPGAs (field programmable gate array) may be utilized in the processor modules as a fabric interface on the processor modules as shown in FIG. 1C. These fabric interfaces provide a 64/66 Mhz PCI interface to the interface converter circuits 1082. FIG. 1E illustrates a functional block diagram of such a fabric interface 34. As explained below, the interface 34 provides an interface between the processor module bus and the UDASL switch interface converter circuit 1082. As shown in FIG. 1E, at the switch fabric side, a physical connection interface 41 provides connectivity at the physical level to the switch fabric. An example of interface 41 is a parallel bus interface complying with the UTOPIA standard. In the example of FIG. 1E, interface 41 is a UTOPIA 3 interface providing a 32-bit 110 Mhz connection. However, the concepts disclosed herein are not protocol dependent and the switch fabric need not comply with any particular ATM or non ATM standard.

Still referring to FIG. 1E, SAR (segmentation and reassembly) unit 42 has appropriate SAR logic 42a for performing segmentation and reassembly tasks for converting messages to fabric cells and vice-versa as well as message classification and message class-to-queue routing, using memory 42b and 42c for transmit and receive queues. This permits different classes of messages and permits the classes to have different priority. For example, control messages can be classified separately from data messages, and given a different priority. All fabric cells and the associated messages may be self routing, and no out of band signaling is required.

A special memory modification scheme permits one processor module to write directly into memory of another. This feature is facilitated by switch fabric interface 34 and in particular by its message classification capability. Commands and messages follow the same path through switch fabric interface 34, but can be differentiated from other control and data messages. In this manner, processes executing on processor modules can communicate directly using their own memory spaces.

Bus interface 43 permits switch fabric interface 34 to communicate with the processor of the processor module via the module device or I/O bus. An example of a suitable bus architecture is a PCI architecture, but other architectures could be used. Bus interface 43 is a master/target device, permitting interface 43 to write and be written to and providing appropriate bus control. The logic circuitry within interface 43 implements a state machine that provides the communications protocol, as well as logic for configuration and parity.

Referring again to FIG. 1C, network processor 1032 (for example a MOTOROLA C-Port C-5 network processor) of the network interface processing engine 1030 may be coupled directly to an interface converter circuit 1082 as shown. As mentioned above and further shown in FIG. 1C, the network processor 1032 also may be coupled to the network 1020 by using a VITESSE GbE SERDES (serializer-deserializer) device (for example the VSC7123) and an SFP (small form factor pluggable) optical transceiver for LC fibre connection.

The processor modules 1003 include a fibre channel (FC) controller as mentioned above and further shown in FIG. 1C. For example, the fibre channel controller may be the LSI SYMFC929 dual 2GBaud fibre channel controller. The fibre channel controller enables communication with the fibre channel 1092 when the processor module 1003 is utilized as a storage processing engine 1040. Also illustrated in FIG. 1C is optional adjunct processing unit 1300 that employs a POWER PC processor with SDRAM. The adjunct processing unit is shown coupled to network processor 1032 of network interface processing engine 1030 by a PCI interface. Adjunct processing unit 1300 may be employed for monitoring system parameters such as temperature, fan operation, system health, etc.

As shown in FIG. 1C, each processor module of content delivery engines 1030, 1040, 1050, 1060, and 1070 is provided with its own synchronous dynamic random access memory (“SDRAM”) resources, enhancing the independent operating capabilities of each module. The memory resources may be operated as ECC (error correcting code) memory. Network interface processing engine 1030 is also provided with static random access memory (“SRAM”). Additional memory circuits may also be utilized as will be recognized by those skilled in the art. For example, additional memory resources (such as synchronous SRAM and non-volatile FLASH and EEPROM) may be provided in conjunction with the fibre channel controllers. In addition, boot FLASH memory may also be provided on the of the processor modules.

As described above, the checksum techniques provided herein may utilize buffer descriptor control blocks (or other control mechanisms) of a data movement engine such as a DMA engine, which is common practice. FIG. 6 is an illustrative buffer descriptor control block that may utilize the checksum techniques described herein. It will be recognized, however, that other control mechanisms may be utilized and the inventions provided herein are not limited to the buffer descriptor control block shown herein. Rather, the buffer descriptor control block of FIG. 6 is merely provided to illustrate an exemplary control mechanism that incorporates checksum flags and payload offsets values for use in a DMA engine that performs checksum operations.

FIG. 6 illustrates a buffer descriptor control block 600 that may be used for transmitting both control and data protocal data units (PDUs). The exemplary buffer descriptors shown herein may reside in system RAM with the fields set as little-endian since they may be mastered from system RAM via a PCI bus which is little-endian in nature. As shown in FIG. 6, the buffer descriptor control block 600 may include Physical Address of Next Buffer Descriptor 601. This 32-bit physical address points, in system RAM, to the next buffer descriptor in a buffer chain, either Tx (transmit) or Rx (receive) queue. The buffer descriptor control block 600 may also include Reserved (64-bit Physical Address Extension) Field 602. This field may be reserved to provide extensibility for 64-bit addressability while also providing Quad-word (64-bit) alignment for the remaining portion of the Buffer Descriptor.

The buffer descriptor control block 600 may further include a Buffer Descriptor Flags field 603, and Number of Buffers field 604. This two fields constitute a single 32-bit word that may be overwritten, in a single cycle, by the transmit and receive DMA engines upon completion of a Buffer Descriptor operation. Buffer Descriptor Flags field 603 provides a 16-bit little-endian (PCI native order) field indicating buffer descriptor function and status. A variety of function and status flags may be provided. For example, the checksum flag described above may be included in this field. Exemplary other flags include HARDWARE_OWNERSHIP. This flag indicates whether code on the host processor ‘owns’ a descriptor or the DMA engine. For receive operations this indicates that a buffer descriptor is ready for DMA use. The DMA engine will clear this bit when it completes the receive transfer operation. For transmit operations it indicates that the DMA hardware is not done with the buffer descriptor, yet. When transmit operations are complete for a given buffer descriptor, this flag is cleared (zeroed) by the DMA transmitter. When either the transmit or receive DMA engines encounter a buffer descriptor without the Hardware Ownership flag set, DMA operations are quiesced since this event is interpreted as an end-of-chain condition (i.e. no more buffers available). In this quiesced state, any incoming PDUs are discarded due to a lack of buffer resources. The GENERATE_PAYLOAD_CHECKSUM flag instructs the DMA transmit engine to generate a 32-bit checksum trailer as part of the PDU. In the exemplary embodiment described, this flag is only valid for transmit buffer descriptors. When this flag is set, the Payload Offset and Non-header Payload Size fields should be set to indicate the starting offset within the PDU where the checksum calculation is to start and the associated length. The PDU_HEADER_SEPARATION flag indicates that the receiving entity wants the PDU header portion of incoming PDUs placed in separate memory from the PDU payload data. This feature allows exact memory placement of PDU payload data. When this flag is ON, the Rx DMA engine places the incoming PDU header, by default, in the Buffer Descriptor's PDU Header Space field. If this flag is OFF, the Rx DMA engine places the incoming PDU header and payload data in memory contiguously with regards to the receive buffer structure. The RECEIVE_ERROR flag indicates a receive error occurred for the associated PDU. The Rx buffer descriptor may, or may not, contain data depending upon the Rx state when the error was encountered. The Rx DMA engine thus proceeds to the next Rx buffer descriptor. The TRANSMIT_PARM_ERROR flag indicates that the Tx DMA engine encountered a set of transmit parameters that were invalid. When this buffer descriptor is marked, the Tx DMA engine proceeds to the next Tx buffer descriptor. The GEN_INTERRUPT flag indicates to the Rx/Tx DMA Engines that an interrupt event is requested when an Rx or Tx operation is completed for the corresponding Buffer Descriptor.

Other flags may be utilized and the flags and descriptions provided herein are listed for illustrative purposes. According to the checksum techniques described herein, it is generally desirable, however, to provide a checksum flag or some other indicator to indicate that the DMA engine is to perform a checksum operation.

The Number of Buffers field 604 is an unsigned 16-bit little endian (native PCI format) field modified/written by both system software (DMA device driver) and the Tx/Rx DMA engines. This means that it has both pre-, and post-, completion values and interpretations. For precompletion values (i.e. the values setup by software to initiate DMA activity), this field indicates the number of transmit or receive buffers associated with the given buffer descriptor. In one example, there may be a one-to-one correlation between a buffer descriptor and a PDU (i.e. a PDU is described to the DMA processor by a single buffer descriptor; a PDU cannot span multiple buffer descriptors). Thus, a transmit PDU can be comprised of up to four buffers plus PDU header space contents. On the receive side, the DMA engine will place an incoming PDU in up to four buffers referenced by a receive buffer descriptor plus placing PDU header contents into the PDU header space field, if desired. Therefore, a fabric switch node is recommended to deploy its receive buffer descriptors with each descriptor referencing enough buffer capacity to successfully receive its advertised maximum PDU size. Otherwise, Receive Overflow occurs in the receive DMA engine. For post-completion values, the Number of Buffers field 604 is overwritten by the Tx DMA engine as part of its update of the adjacent Buffer Descriptor Flags field; therefore its value is nondeterminate after transmit completion. For Rx completion events, this field will bear two values. The lowest order three bits will indicate the last external buffer that received DMA data. This means that it will identify Buffer 1 or Buffer 2 or Buffer 3 or Buffer 4 as being the last buffer to receive data; a zero indicates no external buffers received data. The high-order 13 bits convey the number of bytes that were placed in the last buffer to receive data from the Rx DMA engine. Since only 13 bits are used, the last buffer can only receive up to 8191 bytes of information with accurate notification from the Rx DMA engine using this field. Effectively, any values beyond 8191 become a modulo value of 8192 and would require software on the receiving side to use the PDU Header Payload Size field to determine the actual amount of received data and how it was distributed amongst the associated receive buffers. This utilization of this field allows the Rx DMA engine to perform Rx completion notification in a single PCI write cycle and greatly increases bus utilization. It also eliminates the redundant updating of the buffer size fields for receive buffers that are completely received into (buffer size=rx size).

The PDU Header Size field 605 is a one byte field that indicates the size, in bytes, of the PDU Header information contained in, or that should be received into, the Buffer Descriptor PDU Header Space field. For transmit buffer descriptors, this field is set by the transmitting firmware/software indicating how many bytes of PDU header information are contained in the PDU Header Space field. If no PDU data is present in the PDU Header Space field, this field should be set to zero. For receive buffer descriptors, this field is only relevant if the PDU_HEADER_SEPARATION flag is ON in the Buffer Descriptor Flags field. If this flag is ON, the Rx DMA Engine moves the PDU header of an incoming PDU into the Buffer Descriptor's PDU Header Space field; however, no update of this field is performed by the Rx DMA engine since the received PDU Header contains all the fields necessary to determine the header and payload sizes.

The Payload Offset field 606 is utilized as part of the TCP/UDP checksum processes performed by the DMA engine. The Payload Offset field 606 may be a one byte field that is to be set for transmit PDUs that need payload checksumming to be performed. When the GENERATE_PAYLOAD_CHECKSUM Buffer Flag is set, this field contains the offset from the start of the PDU where the transmit DMA engine is to start computing the payload checksum. This allows the presence of any size, or type, of PDU header fields, without the DMA engine having to be aware of the PDU header structure (since there may be conditional and proprietary extension header fields allowed). The checksum algorithm is the TCP/UDP payload checksum method that is a 32-bit accumulation of 16-bit fields. The 32-bit checksum value is appended to the end of the PDU. Therefore the formula in the Tx DMA engine for generating the size of the PDU data to checksum would be:

ChecksumLength=((PduHeaderSize+PduPayloadSize)−PayloadOffset)

Where ‘PduHeaderSize’ is the standard PDU header size (for example 12 bytes) plus any extension header fields, and ‘PduPayloadSize’ is the PDU Payload size for the associated PDU, and ‘PayloadOffset’ is the value assigned to the Payload Offset Buffer Descriptor field 606. As shown in this illustrative example, this field is not utilized for non-checksummed transmit Buffer Descriptors and all receive Buffer Descriptors targeted for Rx checksum support.

The Sequence Counter ID/Cells Received field is an unsigned 16-bit little endian field that is transmit versus receive dependent in its use and interpretation. For transmit Buffer Descriptors this field identifies the Sequence Counter within the Tx DMA engine to use to generate the Source Sequence Number value. For example, the Tx DMA engine may have 8 counters (IDs 0-7) that get set to their ID values during DMA engine initialization. These counters are to be used to generate the Source Sequence Numbers in transmitted PDUs. Each counter wraps at 255 (8 bit counters). These registers are to be associated with each remote node such that all PDU traffic destined for fabric node ‘4’ would use Sequence Counter ID 0×04 to generate unique Source Sequence Numbers in the headers. For receive Buffer Descriptors this field may indicate the number of cells that comprised the corresponding received PDU.

The Buffer 1-4 Physical Address fields 608 are 32-bit little-endian fields that contain the physical addresses of the buffers that comprise a transmit or receive PDU. The Buffer 1-4 Size/Length fields 609 are 32-bit little endian fields contain the size of the data contained in the associated buffer. For Transmit buffers these fields are set by the transmitting software/firmware to indicate how much data to transmit. For receive operations these fields indicate the buffer capacity of each receive buffer. The PDU Header Space field 610 is reserved to hold up to 80 bytes worth of PDU header data. The PDU Header Size field determines whether or not this field is actually used for Tx PDUs.

The checksum techniques described above are particularly useful for implementation in systems utilizing a distributed interconnect, such as for example, a switch fabric. Thus, in such systems part or all of the checksum process may be incorporated within the prescribed interface mechanisms utilized to move data across the interconnection medium. For example, multi-processor systems such as shown in FIG. 1A may be particularly well suited for incorporating the checksum process within the DMA engine.

Moreover, the entire checksum process need not be performed by one processor engine of the multi-processor system but could be split amongst two or more of the processor engines. The process of splitting the checksum operation across two or more processor engines will be illustrated with reference to a TCP or UDP checksum operation for an outbound packet being transmitted from the transport processing engine 1050 to the network interface processing engine 1030 of FIG. 1A utilizing a DMA engine buffer descriptor control block as described with reference to FIG. 6. In operation, the GENERATE_PAYLOAD_CHECKSUM flag may be set. Further, the Payload Offset field may be set to identify where in the PDU the DMA engine is to start computing the payload checksum. The DMA engine may then place an intermediate checksum accumulation value (checksum operations A, B, and C identified above) at the end of the packet buffer.

The network interface processing engine 1030 may then receive the intermediate checksum accumulation value and perform the checksum store operation (i.e., the operation related to insertion into the header consisting of shifting, adding as 16-bit high and low order values and then one's complimenting the value prior to storing in the header checksum field). The IP checksum operation may be performed entirely by the network interface engine utilizing standard IP checksum techniques.

The technique described above is advantageous because a vast majority of the computing work necessary to complete the TCP or UDP checksum operation is performed by the DMA engine in conjunction with data movement across the switch fabric. Further, the TCP or UDP operations left to the network interface engine are rather minimal and of fixed size and very deterministic. Similarly, the IP layer checksum performed by the network interface engine is generally very deterministic as the IP layer is generally not of variable length and is relatively small in size and well-bounded. Thus, much of the checksum process may be done “on the fly” and the checksum process may take the same time for every packet.

The checksum processes may be accomplished without extensive buffering and packet transmission and reception latencies may be reduced. Moreover, the DMA engine may be relatively “dumb” as the DMA engine need not have an implicit knowledge of the operation constructs but rather merely operates from the checksum flag and payload offset, and places the intermediate accumulated value at the end of the packet buffer.

In this manner a TCP/UDP checksum process has been provided in which checksum generation is incorporated within the data movement engine utilized with a high speed interconnect medium (for example a switch fabric). Much of the checksum process may be performed as part of the data movement process across the medium without greatly increasing system costs or degrading system performance. Moreover, the checksum process may be split up and different operations performed at different steps of the packet transmission process. Thus, portions of the checksum process may be performed on either side of the interconnect medium during the transmission process.

As described in the example above, a TCP/UDP checksum generation process is provided. In the system of FIG. 1A, checksum operations for in-bound packets arriving at the network interface engine 1030 from the external network may be performed by network processors within the network interface engine 1030 because of the inherent functionalities designed in many network processors. However, the checksum techniques described herein related to a data movement engine also may be advantageously used for in-bound packets even with network processors or more advantageously used when a general processor or embedded processor is utilized in the network interface engine.

Though described herein for checksum generation for out-bound packets, the checksum techniques utilized in conjunction with data movement across the interconnect medium thus may be used during in-bound or out-bound data movements and may be used during checksum generation or checksum verification. Thus, the checksum verification calculations in which a checksum value is obtained and then compared to the received checksum value stored in a header may also be similarly accomplished with a DMA engine and across an interconnect medium as described herein for the checksum generation process.

The techniques described herein have been illustrated with regard to a packet to be transmitted or received from an external network. However, it will be recognized that these techniques are also applicable to data transfers within the system itself. So for example, memory to memory moves within the system may be accomplished with a checksum process simultaneously occurring with the move by utilizing the data movement engine.

The checksum techniques described herein also provide flexibility as to which portions of the checksum operation are done at which side of the interconnect medium. Thus, though described with reference to checksum operations A, B. and C being accomplished together, the checksum operations may be divided in a different manner. Further, the DMA engine may be configured to checksum all or any desired portion of the packet. For example, the software can be controlled to selectively checksum the payload, checksum the pseudoheaders, checksum the transport header and the payload, or other combinations thereof.

Thus, utilizing the DMA engine for the checksum operations provides wide ranges of benefits. These techniques do not require extensive buffering or complex logic in the DMA engine. Further packet transmission or reception latencies are minimized since the checksum accumulator value is appended on the back of the payload allowing on the fly generation and verification. In addition these techniques give software control on how the checksum is to be generated by allowing the controlling software to place pseudo headers, or not, in the payload; checksum all or part of the data payload; checksum all or part of the UDP/TCP header space, etc. Further, since the DMA engine takes an offset value on where in the data buffers referenced by the buffer descriptor to start checksum generation (or verification), the software has total control on how much “coprocessing” it needs. These techniques also allow the controlling software to generate accumulator checksums when copying data from memory to memory. If the DMA engine is connected to an interprocessor bus (like PCI or S-Bus or VME, etc.), or a switch fabric (like Prizma, PowerX, or Infiniband), on its backside interface, then this method reduces the buffer and compute requirements, and thereby expense and complexity, of the target coprocessing engine to finish-up the checksum by only requiring that a subset of the checksum operations to be performed by the target coprocessor engine and then subsequent generation of the IP header checksum (which is relatively straightforward, quick and efficient).

In addition, the methods described herein can be implemented in simple, cost-effective PLDs such as the fabric interface FPGAs/ASICs described above. In addition the techniques described herein are viable on any I/O bus interface that allows devices to be memory masters without requiring a network medium to be directly attached to the same bus. Further, this method does not require the DMA engine to have any explicit or implicit knowledge of the buffer contents to perform the checksum calculations. Once again reducing complexity and cost.

It will be understood with benefit of this disclosure that although specific exemplary embodiments of hardware and software have been described herein, other combinations of hardware and/or software may be employed to achieve one or more features of the disclosed systems and methods. Furthermore, it will be understood that operating environment and application code may be modified as necessary to implement one or more aspects of the disclosed technology, and that the disclosed systems and methods may be implemented using other hardware models as well as in environments where the application and operating system code may be controlled.

### REFERENCES

The following references, to the extent that they provide exemplary system, method, or other details supplementary to those set forth herein, are specifically incorporated herein by reference.

U.S. patent application Ser. No. 10/003,683 filed on Nov. 2, 2001 which is entitled “SYSTEMS AND METHODS FOR USING DISTRIBUTED INTERCONNECTS IN INFORMATION MANAGEMENT ENVIRONMENTS”

U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS”

U.S. patent application Ser. No. 09/797,413 filed on Mar. 1, 2001 which is entitled “NETWORK CONNECTED COMPUTING SYSTEM”

U.S. Provisional Patent Application Serial No. 60/285,211 filed on Apr. 20, 2001 which is entitled “SYSTEMS AND METHODS FOR PROVIDING DIFFERENTIATED SERVICE IN A NETWORK ENVIRONMENT,”

U.S. Provisional Patent Application Serial No. 60/291,073 filed on May 15, 2001 which is entitled “SYSTEMS AND METHODS FOR PROVIDING DIFFERENTIATED SERVICE IN A NETWORK ENVIRONMENT”

U.S. Provisional Patent Application Serial No. 60/246,401 filed on Nov. 7, 2000 which is entitled “SYSTEM AND METHOD FOR THE DETERMINISTIC DELIVERY OF DATA AND SERVICES”

U.S. patent application Ser. No. 09/797,200 filed on Mar. 1, 2001 which is entitled “SYSTEMS AND METHODS FOR THE DETERMINISTIC MANAGEMENT OF INFORMATION”

U.S. Provisional Patent Application Serial No. 60/187,211 filed on Mar. 3, 2000 which is entitled “SYSTEM AND APPARATUS FOR INCREASING FILE SERVER BANDWIDTH”

U.S. patent application Ser. No. 09/797,404 filed on Mar. 1, 2001 which is entitled “INTERPROCESS COMMUNICATIONS WITHIN A NETWORK NODE USING SWITCH FABRIC”

U.S. patent application Ser. No. 09/947,869 filed on Sep. 6, 2001 which is entitled “SYSTEMS AND METHODS FOR RESOURCE MANAGEMENT IN INFORMATION STORAGE ENVIRONMENTS”

U.S. patent application Ser. No. 10/003,728 filed on Nov. 2, 2001, which is entitled “SYSTEMS AND METHODS FOR INTELLIGENT INFORMATION RETRIEVAL AND DELIVERY IN AN INFORMATION MANAGEMENT ENVIRONMENT”

U.S. Provisional Patent Application Serial No. 60/246,343, which was filed Nov. 7, 2000 and is entitled “NETWORK CONTENT DELIVERY SYSTEM WITH PEER TO PEER PROCESSING COMPONENTS”

U.S. Provisional Patent Application Serial No. 60/246,335, which was filed Nov. 7,2000 and is entitled “NETWORK SECURITY ACCELERATOR”

U.S. Provisional Patent Application Serial No. 60/246,443, which was filed Nov. 7, 2000 and is entitled “METHODS AND SYSTEMS FOR THE ORDER SERIALIZATION OF INFORMATION IN A NETWORK PROCESSING ENVIRONMENT”

U.S. Provisional Patent Application Serial No. 60/246,373, which was filed Nov. 7, 2000 and is entitled “INTERPROCESS COMMUNICATIONS WITHIN A NETWORK NODE USING SWITCH FABRIC”

U.S. Provisional Patent Application Serial No. 60/246,444, which was filed Nov. 7, 2000 and is entitled “NETWORK TRANSPORT ACCELERATOR”

U.S. Provisional Patent Application Serial No. 60/246,372, which was filed Nov. 7, 2000 and is entitled “SINGLE CHASSIS NETWORK ENDPOINT SYSTEM WITH NETWORK PROCESSOR FOR LOAD BALANCING”

U.S. patent application Ser. No. 09/797,198 filed on Mar. 1, 2001 which is entitled “SYSTEMS AND METHODS FOR MANAGEMENT OF MEMORY”

U.S. patent application Ser. No. 09/797,201 filed on Mar. 1, 2001 which is entitled “SYSTEMS AND METHODS FOR MANAGEMENT OF MEMORY IN INFORMATION DELIVERY ENVIRONMENTS”

U.S. Provisional Application Serial No. 60/246,445 filed on Nov. 7, 2000 which is entitled “SYSTEMS AND METHODS FOR PROVIDING EFFICIENT USE OF MEMORY FOR NETWORK SYSTEMS”

U.S. Provisional Application Serial No. 60/246,359 filed on Nov. 7, 2000 which is entitled “CACHING ALGORITHM FOR MULTIMEDIA SERVERS”

U.S. Provisional patent application No. 60/353,104, filed Jan. 30, 2002, and entitled “SYSTEMS AND METHODS FOR MANAGING RESOURCE UTILIZATION IN INFORMATION MANAGEMENT ENVIRONMENTS,” by Richter et. al

U.S. patent application Ser. No. 10/117,028, filed Apr. 5, 2002, and entitled “SYSTEMS AND METHODS FOR MANAGING RESOURCE UTILIZATION IN INFORMATION MANAGEMENT ENVIRONMENTS” by Richter, et al

U.S. patent application Ser. No. 10/060,940, filed Jan. 30, 2002, and entitled “SYSTEMS AND METHODS FOR RESOURCE UTILIZATION ANALYSIS IN INFORMATION MANAGEMENT ENVIRONMENTS,” by Jackson et al.

U.S. Provisional Patent Application Serial No. 60/353,561, filed Jan. 31, 2002, and entitled “METHOD AND SYSTEM HAVING CHECKSUM GENERATION USING A DATA MOVEMENT ENGINE,” by Richter et al.

U.S. patent application Ser. No. 10/125,065, filed Apr. 18, 2002, and entitled “SYSTEMS AND METHODS FOR FACILITATING MEMORY ACCESS IN INFORMATION MANAGEMENT ENVIRONMENTS,” by Willman et al.

United States provisional patent application no. 60/358,244, filed Feb. 20, 2002, and entitled “SYSTEMS AND METHODS FOR FACILITATING MEMORY ACCESS IN INFORMATION MANAGEMENT ENVIRONMENTS,” by Willman et. al

U.S. patent application Ser. No. 10/236,467 filed Sep. 6, 2002, and entitled “SYSTEM AND METHODS FOR READ/WRITE I/O OPTIMIZATION IN INFORMATION MANAGEMENT ENVIRONMENTS,” by Richter.

U.S. patent application Ser. No.______ filed concurrently herewith on Oct. 22, 2002, and entitled “SYSTEMS AND METHODS FOR INTERFACING ASYNCHRONOUS AND NON-ASYNCHRONOUS DATA MEDIA,” by Richter (Atty Dkt. SURG-164).

What is claimed is:

1. A method of performing one or more packet integrity operations, comprising performing said one or more packet integrity operations on at least a portion of the packet data contained in a data packet; wherein at least one of said packet integrity operations is performed on said packet data by a system data movement engine.

2. The method of claim 1, wherein said one or more packet integrity operations comprise at least a portion of a cyclic redundancy check generation or verification process, or at least a portion of a checksum generation or verification process.

3. The method of claim 2, wherein system data movement engine comprises a DMA engine.

4. The method of claim 1, wherein said system data movement engine is coupled to a distributed interconnect.

5. The method of claim 4, wherein said method further comprises at least one of:
using said system data movement engine to perform said at least one of said packet integrity operations in conjunction with receiving said data packet in said system data movement engine across said distributed interconnect; or
using said system data movement engine to perform said at least one of said packet integrity operations in conjunction with transmitting said data packet from said system data movement engine across said distributed interconnect.

6. The method of claim 5, wherein said distributed interconnect comprises a switch fabric.

7. The method of claim 1, wherein said method further comprises performing at least one of said packet integrity operations on at least a portion of said packet data using a first processing engine; and performing at least one other of said packet integrity operations on at least a portion of said packet data using a second processing engine; wherein said first process engine comprises said system data movement engine.

8. The method of claim 7, wherein said method further comprises performing at least one of a first TCP packet integrity operation or a first UDP packet integrity operation on at least a portion of said packet data using said first processing engine; and performing at least one of a second TCP packet integrity operation or a second UDP packet integrity operation on at least a portion of said packet data using said second processing engine.

9. A method of performing one or more packet integrity operations, comprising using a DMA engine to perform at least one packet integrity operation on at least a portion of the packet data contained in a data packet.

10. The method of claim 9, wherein said at least one packet integrity operation comprises at least a portion of a cyclic redundancy check generation or verification process.

11. The method of claim 9, wherein said packet integrity operation comprises at least a portion of a checksum generation or verification process.

12. The method of claim 11, wherein said data packet comprises at least one of a TCP checksum operation or a UDP checksum operation.

13. The method of claim 12, wherein said DMA engine is coupled to a distributed interconnect.

14. The method of claim 13, wherein said distributed interconnect comprises a switch fabric.

15. The method of claim 14, wherein said method further comprises performing at least one first packet integrity operation on at least a portion of said packet data using a first processing engine; and performing at least one second packet integrity operation on at least a portion of said packet data using a second processing engine; wherein said first process engine comprises said DMA engine; and wherein said first and second processing engines are communicatively coupled by said distributed interconnect.

16. The method of claim 15, wherein said first and second processing engines comprise a part of a computing system having a plurality of processing engines communicating in a peer to peer environment across said distributed interconnect.

17. The method of claim 16, wherein said method further comprises performing said at least one first packet integrity operation on at least a portion of said packet data before or in conjunction with transmitting said data packet from said first processing engine across said distributed interconnect to said second processing engine; and performing said at least one second packet integrity operation on at least a portion of said packet data after or in conjunction with receiving said data packet in said second processing engine from said first processing engine.

18. The method of claim 17, wherein said at least one first packet integrity operation comprises at least one of a TCP checksum accumulation operation or a UDP checksum accumulation operation; and wherein said at least one second packet integrity operation comprises at least one of a TCP checksum store operation or a UDP checksum store operation.

19. The method of claim 18, wherein said at least one second packet integrity operation further comprises an IP checksum operation.

20. A computing system, comprising a system data movement engine configured to perform one or more packet integrity operations on at least a portion of the packet data contained in a data packet.

21. The system of claim 20, wherein said one or more packet integrity operations comprise at least a portion of a cyclic redundancy check generation or verification process, or at least a portion of a checksum generation or verification process.

22. The system of claim 20, wherein system data movement engine comprises a DMA engine.

23. The system of claim 22, wherein said packet integrity operation comprises at least a portion of a checksum generation or verification process.

24. The system of claim 23, wherein said DMA engine is coupled to a distributed interconnect.

25. The system of claim 24, wherein said distributed interconnect comprises a switch fabric.

26. The system of claim 25, further comprising a plurality of processing engines communicating in a peer to peer environment across said distributed interconnect, said plurality of processing engines comprising a first processing engine and a second processing communicatively coupled by said distributed interconnect; wherein said first processing engine comprises said DMA engine and is configured to perform at least one first packet integrity operation on at least a portion of said packet data; and wherein said second processing engine is configured to perform at least one second packet integrity operation on at least a portion of said packet data.

27. The system of claim 26, wherein said at least one first packet integrity operation comprises at least one of a TCP checksum accumulation operation or a UDP checksum accumulation operation; and wherein said at least one second packet integrity operation comprises at least one of a TCP checksum store operation or a UDP checksum store operation.

28. A method of performing packet integrity operations using a plurality of processing engines, comprising:
using a first processing engine to perform at least one first packet integrity operation of a packet integrity process on at least a portion of the packet data contained in a data packet;
transmitting said data packet from said first processing engine to at least one second processing engine; and
using said at least one second processing engine to perform at least one second packet integrity operation of said packet integrity process on at least a portion of packet data contained in said data packet.

29. The method of claim 28, wherein said method further comprises using said first processing engine to perform said first packet integrity operation on a selected portion of the packet data contained in said data packet

30. The method of claim 28, wherein said first and second packet integrity operations comprise respective first and second portions of a cyclic redundancy check process.

31. The method of claim 28, wherein said first and second packet integrity operations comprise respective first and second portions of a checksum process.

32. The method of claim 31, wherein said checksum operations comprise at least one of a TCP checksum operation or a UDP checksum operation.

33. The method of claim 32, wherein said first and second processing engines are communicatively coupled by a distributed interconnect; wherein said first processing engine comprises a system data movement engine; and wherein said at least one first packet integrity operation is performed by said system data movement engine in conjunction with data movement across said distributed interconnect.

34. The method of claim 33, wherein said system data movement engine comprises a DMA engine.

35. The method of claim 34, wherein said distributed interconnect comprises a switch fabric.

36. The method of claim 35, wherein said method further comprises using said DMA engine to perform said at least one first packet integrity operation on at least a portion of said packet data before or in conjunction with transmitting said data packet from said first processing engine across said distributed interconnect to said second processing engine; and using said second processing engine to perform said at least one second packet integrity operation on at least a portion of said packet data after or in conjunction with receiving said data packet in said second processing engine from said first processing engine.

37. The method of claim 36, wherein said first and second processing engines comprise a part of a network connected computing system having a plurality of processing engines communicating in a peer to peer environment across said distributed interconnect.

38. The method of claim 37, wherein said at least one first packet integrity operation comprises at least one of a TCP checksum accumulation operation or a UDP checksum accumulation operation; and wherein said at least one second packet integrity operation comprises at least one of a TCP checksum store operation or a UDP checksum store operation.

39. The method of claim 38, wherein said performing said at least one first packet integrity operation comprises obtaining an intermediate TCP or UDP checksum value and appending said intermediate TCP or UDP checksum value to the end of a packet transmission buffer of said data packet; and wherein said performing said at least one second packet integrity operation comprises obtaining a final TCP or UDP checksum value and storing said final TCP or UDP checksum value in the header checksum field of said data packet.

40. The method of claim 39, wherein said performing said at least one first packet integrity operation comprises obtaining said intermediate TCP or UDP checksum value on a payload portion of said packet data.

41. The method of claim 39, wherein said network connected computing system comprises a network connected content delivery system; wherein said first processing engine comprises a transport processing engine; wherein said second processing engine comprises a network interface processing engine; and wherein said network interface processing is coupled to said network.

42. The method of claim 41, wherein said at least one second packet integrity operation further comprises an IP checksum operation.

43. A computing system, comprising:
a first processing engine and at least one second processing engine;
wherein said first processing engine is configured to perform at least one first packet integrity operation of a packet integrity process on at least a portion of the packet data contained in a data packet, and to transmit said data packet from said first processing engine to at least one second processing engine; and
wherein said at least one second processing engine is configured to perform at least one second packet integrity operation of said packet integrity process on at least a portion of packet data contained in said data packet.

44. The system of claim 43, wherein said first processing engine is configured to perform said first packet integrity operation on a selected portion of the packet data contained in said data packet.

45. The system of claim 43, wherein said first and second packet integrity operations comprise respective first and second portions of a checksum process.

46. The system of claim 45, wherein said first and second processing engines are communicatively coupled by a distributed interconnect; wherein said first processing engine comprises a system data movement engine; and wherein said system data movement engine is configured to perform said at least one first packet integrity operation in conjunction with data movement across said distributed interconnect.

47. The system of claim 46, wherein said system data movement engine comprises a DMA engine.

48. The system of claim 47, wherein said distributed interconnect comprises a switch fabric.

49. The system of claim 48, wherein said first and second processing engines comprise a part of a network connectable computing system having a plurality of processing engines communicating in a peer to peer environment across said distributed interconnect.

50. The system of claim 49, wherein said at least one first packet integrity operation comprises at least one of a TCP checksum accumulation operation or a UDP checksum accumulation operation; and wherein said at least one second packet integrity operation comprises at least one of a TCP checksum store operation or a UDP checksum store operation.

51. The system of claim 50, wherein said network connectable computing system comprises a network connectable content delivery system; wherein said first processing engine comprises a transport processing engine; wherein said second processing engine comprises a network interface processing engine; and wherein said network interface processing is coupled to said network.

52. The system of claim 51, wherein said at least one second packet integrity operation further comprises an IP checksum operation.

53. A method of performing one or more packet integrity operations, comprising at least one of:
using a first processing engine to perform at least one packet integrity operation of a packet integrity generation process on at least a portion of the packet data contained in a first data packet, and transmitting said first data packet from said first processing engine to at least one other processing engine, wherein said at least one packet integrity operation of said packet integrity generation process is performed by said first processing engine in conjunction with movement of said data packet from said first processing engine to said at least one other processing engine; or
receiving a second data packet in a second processing engine from at least one other processing engine, and using said second processing engine to perform at least one packet integrity operation of a packet integrity verification process on at least a portion of the packet data contained in said second data packet, wherein said at least one packet integrity operation of said packet integrity verification process is performed by said second processing engine in conjunction with movement of said data packet from said at least one other processing engine to said second processing engine; or
a combination thereof.

54. The method of claim 53, wherein said packet integrity generation process comprises a cyclic redundancy check process, and wherein said packet integrity verification process comprises a cyclic redundancy check process.

55. The method of claim 53, wherein said packet integrity generation process comprises a checksum generation process, and wherein said packet integrity verification process comprises a checksum verification process.

56. The method of claim 55, wherein said first processing engine comprises a system data movement engine; wherein said method comprises using said system data movement engine to perform at least one packet integrity operation of said checksum generation process on at least a portion of the packet data contained in said first data packet in conjunction with outbound movement of said first data packet from said first processing engine.

57. The method of claim 56, wherein said system data movement engine comprises a DMA engine; and wherein said at least one packet integrity operation of said checksum generation process comprises obtaining a checksum value and appending said checksum value to the end of a packet transmission buffer of said first data packet.

58. The method of claim 55, wherein said second processing engine comprises a system data movement engine; and wherein said method comprises using said system data movement engine to perform at least one packet integrity operation of said checksum verification process on at least a portion of the packet data contained in said second data packet in conjunction with inbound movement of said data packet to said second processing engine.

59. The method of claim 58, wherein said system data movement engine comprises a DMA engine; and wherein said at least one packet integrity operation of said checksum verification process comprises receiving a checksum value appended to the end of a packet transmission buffer of said second data packet, and verifying the checksum value on the remaining packet data.

60. The method of claim 55, wherein said first processing engine comprises a system data movement engine; wherein said method comprises using said system data movement engine to perform at least one packet integrity operation of said checksum generation process on at least a portion of the packet data contained in said first data packet, and transmitting said first data packet from said first processing engine to said at least one other processing engine

61. The method of claim 55, wherein said second processing engine comprises a system data movement engine; wherein said method comprises receiving said second data packet in said second processing engine from said at least one other processing engine, and using said system data movement engine to perform at least one packet integrity operation of a checksum verification process on at least a portion of the packet data contained in said second data packet.

62. The method of claim 53, further comprising:
using said first processing engine to perform at least one packet integrity operation of a packet integrity generation process on at least a portion of the packet data contained in a first data packet, and transmitting said first data packet from said first processing engine to said at least one other processing engine, wherein said at least one packet integrity operation of said packet integrity generation process is performed by said first processing engine in conjunction with transmission of said data packet from said first processing engine; and
receiving said second data packet in said second processing engine from said at least one other processing engine, and using said second processing engine to perform at least one packet integrity operation of a packet integrity verification process on at least a portion of the packet data contained in said second data packet in conjunction with receipt of said second data packet in said second processing engine.

63. The method of claim 55, wherein said method further comprises at least one of:
transmitting said first data packet from said first processing engine to said at least one other processing engine across a distributed interconnect; or
receiving said second data packet in said second processing engine from said at least one other processing engine across a distributed interconnect.

64. The method of claim 63, wherein said distributed interconnect comprises a switch fabric.

65. The method of claim 63, wherein said first and second processing engines each comprise a part of a network connected computing system having a plurality of processing engines communicating in a peer to peer environment across said distributed interconnect.

66. The method of claim 65, wherein said network connected computing system comprises a network connected content delivery system.

67. A computing system, comprising at least one of:
a first processing engine configured to perform at least one packet integrity operation of a packet integrity generation process on at least a portion of the packet data contained in a first data packet, and to transmit said first data packet from said first processing engine to at least one other processing engine, wherein said first processing engine is further configured to perform said at least one packet integrity operation of said packet integrity generation process in conjunction with movement of said data packet from said first processing engine to said at least one other processing engine; or
a second processing engine configured to receive a second data packet from at least one other processing engine, and to perform at least one packet integrity operation of a packet integrity verification process on at least a portion of the packet data contained in said second data packet, wherein said second processing engine is further configured to perform said at least one packet integrity operation of said packet integrity verification process in conjunction with movement of said data packet from said at least one other processing engine to said second processing engine; or
a combination thereof.

68. The system of claim 67, wherein said packet integrity generation process comprises a checksum generation process, and wherein said packet integrity verification process comprises a checksum verification process.

69. The system of claim 68, wherein said first processing engine comprises a system data movement engine configured to perform at least one packet integrity operation of said checksum generation process on at least a portion of the packet data contained in said first data packet in conjunction with outbound movement of said first data packet from said first processing engine.

70. The system of claim 68, wherein said second processing engine comprises a system data movement engine; and wherein said method comprises using said system data movement engine to perform at least one packet integrity operation of said checksum verification process on at least a portion of the packet data contained in said second data packet in conjunction with inbound movement of said data packet to said second processing engine.

71. The system of claim 67, wherein said system comprises said first and second processing engines; and
wherein said first processing engine is configured to perform at least one packet integrity operation of a packet integrity generation process on at least a portion of the packet data contained in a first data packet, and to transmit said first data packet from said first processing engine to said at least one other processing engine, and wherein said first processing engine is further configured to perform said at least one packet integrity operation of said packet integrity generation process in conjunction with transmission of said first data packet from said first processing engine; and
wherein said second processing engine is configured to receive said second data packet from at least one other processing engine, and to perform at least one packet integrity operation of a packet integrity verification process on at least a portion of the packet data contained in said second data packet in conjunction with receipt of said second data packet in said second processing engine.

72. The system of claim 68, wherein said distributed interconnect comprises a switch fabric.

73. The system of claim 68, wherein said first and second processing engines each comprise a part of a network connectable computing system having a plurality of processing engines communicating in a peer to peer environment across said distributed interconnect.

74. The system of claim 73, wherein said network connectable computing system comprises a network connectable content delivery system.
